(19) United States
(12) Patent Application Publication
(10) Pub. No.: US 2011/0045130 A1
(43) Pub. Date: Feb. 24, 2011

(54) BIOACTIVE PEPTIDE PRODUCTION

(76) Inventors: Luppo Edens, Rotterdam (NL); Lucas Cyril Gerard Van Der Heyden, Den Haag (NL)

Correspondence Address: NIXON & VANDERHYE, PC, 901 NORTH GLEBE ROAD, 11TH FLOOR, ARLINGTON, VA, 22203, US

(21) Appl. No.: 12/744,107

(22) PCT Filed: Nov. 19, 2008
(86) PCT No.: PCT/EP08/65849

§ 371 Date: Nov. 5, 2010

(30) Foreign Application Priority Data
Nov. 23, 2007 (EP) 07121432.4
Nov. 29, 2007 (EP) 07121873.9
Dec. 12, 2007 (EP) 07123029.6

(51) Int. Cl. A23C 9/127; A23K 1/16; A23L 1/305

(52) U.S. Cl. 426/35; 426/43; 426/442; 426/580

(57) ABSTRACT

The present invention relates to a process to produce the tripeptide IPP and/or the tripeptide VPP which comprises using a protein as starting material, whereby the protein is subjected to a fermentation step using a suitable lactic acid bacterium or a Bifidobacterium and to an enzyme incubation step using a proline-specific endoprotease or a proline specific oligopeptidase.

### FIELD OF THE INVENTION

The present invention relates to the production of bioactive peptides.

### BACKGROUND OF THE INVENTION

Hypertension is a relatively common disease state in humans and presents a prevalent risk factor for cardiovascular diseases, kidney failure and stroke. The availability of a large array of pharmaceutical products such as calcium blockers, beta blockers, diuretics, alpha blockers, central alpha antagonists, angiotensin II antagonists and ACE inhibitors, illustrates that the underlying physiological mechanisms for hypertension are many-sided.

Of the physiological mechanisms for hypertension, especially the renin-angiotensin mechanism has received a lot of scientific attention. In this mechanism, angiotensin is secreted by the liver and is cleaved by the peptidase renin to yield the biologically inactive decapeptide angiotensin I. As angiotensin I passes through the lung capillaries, another peptidase called angiotensin converting enzyme (hereinafter referred to as ACE) acts on angiotensin I by removing the last two residues of angiotensin I (His-Leu) to form the octapeptide angiotensin II. The angiotensin II octapeptide exhibits strong vasoconstricting activity and therefore raises blood pressure. ACE inhibition leading to lower levels of the angiotensin II prevents vasoconstriction and thus high blood pressures.

Apart from cleaving angiotensin I, ACE can also hydrolyse bradykinin, a nonapeptide also participating in blood pressure regulation. In the latter mechanism ACE inhibition leads to increased bradykinin levels which promote vasodilatation and lower blood pressure as well. Inhibiting ACE thus leads to blood pressure lowering effects via at least two separate mechanisms.

It is also known that the octapeptide angiotensin II stimulates the release of aldosterone by the adrenal cortex. The target organ for aldosterone is the kidney where aldosterone promotes increased reabsorbtion of sodium from the kidney tubules. Also via this third mechanism ACE inhibition reduces blood pressure but in this case by diminishing sodium reabsorption.

Because of its multiple physiological effects, inhibiting the proteolytic activity of ACE is an effective way of depressing blood pressure. This observation has resulted in a number of effective pharmaceutical blood pressure lowering products such as captopril and enalapril (Ondetti, M. A. et al., 1977, Science, Washington D.C., 196, 441-444).

Because hypertension is a relatively common disease state it would be advantageous to counteract this undesirable result of modern life style with mildly active natural ingredients, especially mildly active natural ingredients that can be incorporated into food or beverage products because such products are consumed on a regular basis. Alternatively such mildly active natural ingredients could be incorporated into dietary supplements. During the last decades it was discovered that specific peptides present in fermented milk have an ACE inhibiting capacity and can induce blood pressure reductions in hypertensive subjects. Nowadays numerous in vitro and in vivo trials have demonstrated ACE inhibiting effects of different peptides obtained from a variety of protein sources. Although in vitro ACE inhibition assays have revealed many different peptide sequences, it has to be emphasized that ACE inhibiting peptides need to circulate in the blood to exert an in vivo effect. The implication is that efficacious ACE inhibiting peptides should resist degradation by the gastrointestinal proteolytic digestion system and should remain intact during a subsequent transport over the intestinal wall.

A structure-function study of the various ACE inhibiting peptides has suggested that they often posses a Pro-Pro, Ala-Pro or Ala-Hyp at their C-terminal sequence (Maruyama, S. and Suzuki, H., 1982; Agric Biol Chem., 46(5): 1393-1394). This finding is partly explained by the fact that ACE is a peptidyl dipeptidase (EC3.4.15.1) unable to cleave peptide bonds involving proline. Thus from tripeptides having the structure Xaa-Pro-Pro the dipeptide Pro-Pro cannot be removed because the Xaa-Pro bond cannot be cleaved. It is therefore conceivable that if present in relatively high concentrations, tripeptides having the Xaa-Pro-Pro structure will inhibit ACE activity. As not only ACE but almost all proteolytic enzymes have difficulties in cleaving Xaa-Pro or Pro-Pro bonds, the notion that the presence of (multiple) proline residues at the carboxyterminal end of peptides results in relatively protease resistant molecules is almost self-evident. Similarly peptides containing hydroxyproline (Hyp) instead of proline are relatively protease resistant. From this it can be inferred that peptides carrying one or more (hydroxy)proline residues at their carboxyterminal end are likely to escape from proteolytic degradation in the gastro-intestinal tract. These conclusions will help us to understand the remarkable in vivo blood pressure lowering effect of specific ACE inhibiting peptides: not only do they meet the structural requirements for ACE inhibition, they also resist degradation by the gastrointestinal proteolytic digestion system and remain intact during a subsequent transport over the intestinal wall.

Strong ACE inhibiting activities have been reported for the tripeptides Leu-Pro-Pro (LPP; JP02036127), Val-Pro-Pro (VPP; EP 0 583 074) and Ile-Pro-Pro (IPP; J. Dairy Sci., 78:777-7831995). Initially all ACE inhibiting peptides were characterized on the basis of their in vitro effect on ACE activity and the tripeptides Ile-Pro-Pro (hereinafter referred to as IPP) Val-Pro-Pro (hereinafter referred to as VPP) and Leu-Pro-Pro (hereinafter referred to as LPP) stood out because of their strong ACE inhibiting effect resulting in relatively low IC50 values. Later on the presumed antihypertensive effects of the tripeptides VPP as well as IPP could be confirmed in spontaneously hypertensive rats (Nakamura et al., J. Dairy Sci., 78:12531257 (1995)). In these experiments the inhibitory tripeptides were derived from lactic acid bacteria fermented milk. During the milk fermentation the desirable peptides are produced by proteinases produced by the growing lactic acid bacteria. A drawback of this fermentative approach is that lactic acid bacteria are living organisms for which the type and quantity of the enzymes produced are difficult to control. The production of the ACE inhibiting peptides is therefore hardly reproducible and it is also unlikely that the optimal set of enzymes is being produced to ensure the maximal yield of the required peptides. Also the required fermentation times are relatively long which in combination with the low yields implies an unfavorable cost structure for the bioactive peptides. Despite these disadvantages several fermented milk products have been introduced as health food incorporating a natural, bio-active peptide preventing high blood pressures. Additionally, ACE inhibiting peptides have been concentrated from fermented milk products after electro dialysis, hollow fiber membrane dialysis or chromatographic methods to enable their marketing in the form of concentrated dietary supplements like tablets or lozenges.

The above mentioned drawbacks of the fermentative production route were recognized in for example patent applications WO 01/68115, EP 1 231 279, WO 06/67163 and WO 07/013426. In WO 06/67163 a purely enzymatic process is described to recover the tripeptides Val-Pro-Pro and Ile-Pro-Pro of Leu-Pro-Pro from milk casein. The application claims a method for producing these tripeptides by digesting material containing milk casein with a proteinase and a peptidase via an intermediate peptide. Each of these enzyme incubations may take as long as 12 hours and take place under conditions that favor outgrowth of microbial contaminants. Prior to incubation with the peptidase, the intermediate peptide is preferably purified and high end concentrations of ACE inhibiting peptides can only be obtained after an additional chromatographic purification step of the intermediate peptide.

In EP1908354 fermented milk is produced by first digesting casein with a papain, bromelain or other closely related protease, followed by a fermentation using a lactic acid bacterium. Comparative Examples 7-9 of EP1908354 show that the use of papain and bromelain result in improved VPP and IPP content of the fermented milk product whereas other Aspergillus enzymes, which are known to have the ability to produce VPP and IPP, results in lowered VPP and IPP content. It was concluded that only papain and bromelain together with the VPP and IPP producing Lactobacillus Helveticus are able to produce high amounts of VPP and IPP because of their synenergetic effect.

WO2004/098309 uses a VPP and IPP producing lactic acid bacterium (Lactobacillus Helveticus) in combination with an enzyme preparation of Aspergillus oryzae. WO2004/098309 discloses that many proteolytic enzyme preparations are not useful in the preparation of a fermented milk product having a high VPP and IPP content. Moreover the Aspergillus oryzae preparations that are found to be useful, need to be added in amount of 2 to 10 wt % based on casein. In the examples 5 wt % enzyme was used, and only in Example 13-15, the enzyme amount was varied. Molar yields of more than 50% VPP or IPP were only obtained using more than 4 wt % of enzyme. Furthermore the fermented VPP and IPP containing products of WO2004/098309 have all a DH of at least 37%. In general, hydrolysed products having such high DH are known for off-flavours. Moreover a high DH is correlated to decreased suitability for direct incorporation into solid food and creates strict organoleptic limitations by the poor palatability thereof.

Therefore there is a need for a process to produce a fermented milk product which comprises high amounts of VPP and IPP and which solves the problems of the prior art processes.

### SUMMARY OF THE INVENTION

The present invention relates to a process in which bio-active, preferably ACE-inhibiting, tripeptides are generated in high yields. The process according to the present invention comprises a fermentation step using a lactic acid bacterium or Bifidobacterium in combination with an enzyme incubation step in which an added protease, preferably an endoprotease which cleaves at the carboxy terminus of proline present in the amino acid sequence of a protease or peptide, more preferably a proline specific endoprotease or a proline specific oligopeptidase, most preferably a proline specific endoprotease, is used. Preferably the proline-specific protease cleaves peptides and proteins at the carboxy-terminus of proline present in the peptide or protein. Optionally an aminopeptidase is added together with the proline-specific protease. Preferably the aminopeptidase is obtained from an Aspergillus species.

The enzyme incubation can be carried out either prior to the fermentation process, or, alternatively, simultaneously with the fermentation process or even after the completion of the fermentation process. Preferably the incubation is carried out simultaneously with the fermentation process. In applications in which the presence of viable microorganisms in the end product is required, for example in specific yogurts or probiotic preparations, the enzyme incubation is preferably carried out prior to the fermentation process. According to the invention, the fermentation takes place using a lactic acid bacterium or Bifidobacterium. Examples of suitable lactic acid bacteria and Bifidobacteria include Lactobacillus acidophilus, Lactobacillus bulgaricus, Lactobacillus helveticus, Lactobacillus plantarum, Lactobacillus rhamnosus, as well as Lactococcus species, e.g. Lactococcus lactis, Leuconostoc species, Pediococcus species, Streptocoocus species as well as representants of Bifidobacteria such as Bifidobacterium animalis, Bifidobacterium brevis, Bifidobacterium infantis and Bifidobacterium longum. The process of the invention can be used to produce ACE-inhibitory or antihypertensive tripeptides, as well as immunomodulatory, antioxidative or antimicrobial peptides. Especially the tripeptides IPP, VPP and LPP are preferably produced. By combining fermentation and enzymes according to the invention, advantages of a fermentation process, such as the creation of taste, texture or probiotic activity, are cost-effectively combined with the production of bio-active tripeptides.

So the present invention provides a process to produce a fermented milk product comprising the tripeptide IPP and/or the tripeptide VPP which comprises using a milk protein as starting material, whereby the milk protein is subjected to a fermentation step using a suitable lactic acid bacterium or Bifidobacterium and to an enzyme incubation step using a proline-specific endoprotease or a proline specific oligopeptidase. The present process produces a fermented milk product with high amounts of IPP and/or VPP

Advantageously 0.05 to 1.7 wt % (based on enzyme protein per quantity of milk protein present) of proline-specific endoprotease or proline specific oligopeptidase is used in the present process. Preferably 0.1 to 1.5 wt % and most preferably 0.2 to 1.3 wt % (based on enzyme protein per quantity of milk protein present) of proline-specific endoprotease or proline specific oligopeptidase is used in the present process. The quantity of aminopeptidase used is preferably less than 5 wt %, more preferably less than 3 wt %, most preferably less than 1 wt % (based on enzyme protein per quantity of milk protein present).

### DETAILED DESCRIPTION OF THE INVENTION

Several fermented milk products are nowadays commercially available that contain bioactive ACE-inhibiting peptides such as the tripeptides IPP (Ile-Pro-Pro), LPP (Leu-Pro-Pro) and VPP (Val-Pro-Pro). Although all these products are prepared by fermenting a milk product with well-known lactic acid cultures, the end products obtained typically contain highly variable levels of these ACE-inhibiting tripeptides. These variable levels of ACE-inhibiting tripeptides result in unwanted yield losses and, if the fermented product is used as the end product, in widely divergent blood pressure lowering effects. Such blood pressure lowering effects can be tested according to methods specified in the prior art by in vivo tests using hypertensive rats or in in vitro tests by measuring their ability to inhibit Angiotensin Converting Enzyme (ACE) using methods known in the prior art. The variable levels of ACE-inhibiting tripeptides and thus blood pressure lowering effects can be explained by different milk protein containing starting materials, different fermentation conditions, and differences between the lactic acid cultures used. Furthermore, the nature and the quantities of the ACE-inhibiting tripeptides formed are dependent upon the characteristics of the proteolytic systems that are expressed by the type of lactic acid producing bacteria under the specific fermentation conditions applied. Nowadays it is known that to obtain a significant blood pressure lowering effect in humans, relatively high amounts of the tripeptides IPP, VPP or LPP have to be consumed. Unfortunately, obtaining such high levels of these tripeptides during a fermentation process is not easy: many factors influence the course of the fermentation process and the production of the required proteolytic activities by the lactic acid bacteria or Bifidobacteria used.

Lactic acid producing bacteria are known to produce a vast number of different proteases (see for example Savijoki et al., Appl Microbiol Biotechnol (2006) 71: 394-406). Generating the tripeptides IPP, VPP and LPP from the relevant protein sources, demand a complex interaction between a number of these proteases. Moreover, the various proteases have to be present in substantial amounts. The clotting of the relevant casein fractions by the gradually acidifying milk protein containing fermentation broth, will further complicate the release and the quantitative recovery of these tripeptides from the casein. Because of these complications, it is very hard to direct the fermentation in such a way that certain desired tripeptides are formed in increased and reproducible amounts. The fact that the fermentation process can serve other purposes as well, such as, for example, flavour formation, viscosity, mouth feel improving polysaccharides as well as the production of desirable probiotic or prebiotic ingredients, also has to be taken into account. If such additional targets play a role, the optimization of the fermentation process in terms of maximizing the level of ACE-inhibiting tripeptides becomes even more complex.

We have now surprisingly found that combining a microbial fermentation step with a treatment of the milk protein with a proline specific endoprotease, may result in an increased content of selected ACE-inhibiting tripeptides having a carboxy terminal proline in the final fermentation product. We have found that even products that were fermented using cultures known for their high proteolytic capacities still can be improved to reach higher levels of the tripeptides IPP, VPP and LPP. Moreover we have found that the process according to the invention leads to such higher tripeptide levels in a more reproducible way. Even by using cultures that do not produce the desired ACE-inhibiting tripeptides but were chosen for their flavour forming or probiotic qualities, the process of the present invention resulted in a product with high amounts of ACE-inhibiting tripeptides. In this way the advantages of a fermentation process, optimized for, for example, flavour, polysaccharide or prebiotic or probiotic production, can be combined with the ability to produce high amounts of selected ACE-inhibiting tripeptides. Therefore, the present invention enables commercial producers of fermented milk to make a product that contains increased and standardized amounts of bioactive tripeptides such as IPP, VPP and LPP, simply by the incorporation of an enzymatic step according to the invention into their process.

A “peptide” or “oligopeptide” is defined herein as a chain of at least two amino acids that are linked through peptide bonds. The terms “peptide” and “oligopeptide” are considered synonymous (as is commonly recognized) and each term can be used interchangeably as the context requires. By a “bioactive” peptide is meant a peptide that is able to modulate a physiological process in a mammal. Preferred bioactive peptides produced with the process of the invention are peptides having a proline at their carboxy terminal. Other preferred bioactive peptides are peptides having a blood pressure lowering effect. The most preferred bioactive peptides are IPP, LPP and VPP.

A “polypeptide” is defined herein as a chain comprising of more than 30 amino acid residues. All (oligo)peptide and polypeptide formulas or sequences herein are written from left to right in the direction from amino-terminus to carboxy-terminus, in accordance with common practice. The one-letter code of amino acids used herein is commonly known in the art and can be found in Sambrook, et al. (Molecular Cloning: A Laboratory Manual, 2nd, ed. Cold Spring Harbor Laboratory, Cold Spring Harbor Laboratory Press, Cold Spring Harbor, N.Y., 1989).

By milk protein is meant milk, skim milk, fat free milk, butter milk, yoghurt, milk powder dissolved in water to the desired protein concentration, furthermore caseinate dissolved in water to the desired protein concentration, optionally solutions of caseinate containing whey proteins or solutions of glycomacropeptide (GMP) or combinations of these ingredients have to be understood to be covered by the term milk protein.

By fermented milk product is meant milk protein which is fermented by a lactic acid bacterium or by Bifidobacterium or a combination of such strains.

By hydrolysate (or protein hydrolysate or hydrolysed protein) is meant the product that is formed by the enzymatic hydrolysis of the protein, the acid-soluble hydrolysate being the soluble fraction of the protein hydrolysate which is also described herein as soluble peptide containing composition or composition comprising soluble peptides), or a mixture of a protein hydrolysate and an acid soluble hydrolysate. A hydrolysate is therefore a peptide containing composition, and in the present case a composition containing the tripeptides IPP and VPP.

By bioactive peptide composition is meant the product that is formed by the process of the invention, thus after enzymatic hydrolysis and fermentation of a protein. The acid-soluble bioactive peptide composition being the soluble fraction of the bioactive peptide composition, which is also described herein as soluble bioactive peptides containing composition or composition comprising soluble bioactive peptides, or a mixture of a bioactive peptide composition and an acid soluble, bioactive peptide composition.

The internationally recognized schemes for the classification and nomenclature of all enzymes from IUBMB include proteases. The updated IUBMB text for protease EC numbers can be found at the internet site: http://www.chem.gmw/ac.uk/iubmb/enzyme/EC3/4/11/. In this system enzymes are defined by the fact that they catalyze a single reaction. This has the important implication that several different proteins are all described as the same enzyme, and a protein that catalyses more than one reaction is treated as more than one enzyme. The system categorises the proteases into endo- and exoproteases. The terms “protease”, “proteinase” and “peptidase” are used interchangeably herein. Endoproteases are those enzymes that hydrolyze internal peptide bonds, exoproteases hydrolyze peptide bonds adjacent to a terminal a-amino group (“aminopeptidases”), or a peptide bond between the terminal carboxyl group and the penultimate amino acid (“carboxypeptidases”). The endoproteases are divided into sub-subclasses on the basis of catalytic mechanism. There are sub-subclasses of serine endoproteases (EC 3.4.21), cysteine endoproteases (EC 3.4.22), aspartic endoproteases (EC 3.4.23), metalloendoproteases (EC 3.4.24) and threonine endoproteases (EC 3.4.25).

The aminopeptidases are in EC class 3.4.11. Sub-classification is on the basis of the relative efficiency with which the 20 different amino acids are removed. Aminopeptidases with a narrow and a broad specificity can be distinguished. Aminopeptidases can sequentially remove single amino-terminal amino acids from protein and peptide substrates. Aminopeptidases with a narrow specificity exhibit a strong preference for the type of amino acid residue at the P1 position that is liberated from the substrate peptide. Aminopeptidases of broad specificity are capable of releasing a range of different amino acids at the N-terminal or P1 positions (according to Schechter's nomenclature: Schechter, I. And Berger, A. 1967. Biochem Biophys Res Commun 27:157-162). Carboxypeptidases can sequentially remove single carboxy-terminal amino acids from protein and peptide substrates. Comparable with the situation for the endoproteases, carboxypeptidases are divided into sub-subclasses on the basis of catalytic mechanism The serine-type carboxypeptidases are in class EC 3.4.16, the metallocarboxypeptidases in class EC 3.4.17 and the cysteine-type carboxypeptidases in class EC 3.4.18.The value of the EC list for proteases resides in providing standard terminology for the various types of protease activity and especially in the assignment of a unique identification number and a recommended name to each protease.

WO 02/45524 describes a proline-specific endoprotease obtainable from Aspergillus niger, which can be advantageously used in the present invention. The A. niger derived enzyme cleaves preferentially at the carboxyterminus of proline, but can also cleave at the carboxyterminus of hydroxyproline and, be it with a lower efficiency, at the carboxyterminus of alanine. WO 2002/45524 also teaches that there exists no clear homology between this A. niger derived enzyme and the known prolyl oligopeptidases from other microbial or mammalian sources. In contrast with known prolyl oligopeptidases, the A. niger enzyme has an acid pH optimum. The secreted A. niger enzyme appears to be a member of family S28 of serine peptidases rather than the S9 family into which most cytosolic prolyl oligopeptidases have been grouped (Rawlings, N. D. and Barrett, A. J.; Biochim. Biophys. Acta 1298 (1996) 1-3). Preferably, the A. niger derived enzyme preparation is used as a pure enzyme. As a result highly concentrated ACE inhibiting peptide mixtures characterized by very high proline contents are obtained.

Especially suited for the present invention is an enzyme:
having proline-specific endoprotease activity and
having an amino-acid sequence identical to SEQ ID NO:2 of WO 2002/45523 or having an amino acid sequence which has at least 80%, preferably at least 90% amino acid sequence identity with amino acids 1 to 526 of SEQ ID NO:2 of WO 2002/45523. The level of identity between amino acid sequences is determined by the method mentioned in WO 2002/45523 page 15.

The use of aminopeptidases to obtain tripeptides IPP and VPP from milk protein but without the combination with a fermentative step is described In WO 2006/005757. In WO 2006/005757, three commercial enzyme preparations incorporating an aminopeptidase activity are mentioned, i.e.: Flavourzyme® 1000L (Novozymes, Denmark), Sumizyme® FP (Shin Nihon, Japan) and Corolase® LAP Ch.: 4123 (AB Enzymes, UK). All three enzyme preparations are obtained from Aspergillus species. Both Flavourzyme® and Sumizyme® FP are known to be complex enzyme preparations that contain several aminopeptidolytic enzyme activities besides non-specified endoproteolytic and carboxypeptidolytic activities. Corolase® LAP represents a relatively pure, cloned and overexpressed leucine aminopeptidase activity. In combination with a proline-specific endoprotease, all three mentioned enzyme preparations are able to maximize the yields of the blood pressure lowering tripeptides IPP and VPP from caseinate. However, other enzyme preparations relatively rich in aminopeptidolytic activities may be used as well, for example enzyme preparations such as Peptidase™ 436P-P436P and Peptidase 433P-P433P, both commercially available from Biocatalysts (Wales, UK). Furthermore, the cloned and overexpressed aminopeptidase “ZBH” from A. niger (see sequence number 57 of WO 02/068623, herein referred to as “ZBH”). Aminopeptidases are also known to be produced by other microorganisms than Aspergilli, for example Bacilli and Lactobacilli are known to produce various aminopeptidases. However, for the process according to the present invention, aminopeptidases obtained from Aspergilli are preferred.

Effective ACE inhibiting peptides are likely to incorporate one or two proline residues at the carboxyterminal end of the peptide. The same structural requirement also endows peptides with increased resistance against proteolytic degradation hereby increasing the probability that the intact peptide will end up in the blood stream. To obtain peptides with at least a single but preferably multiple proline residues at their carboxyterminal end, the use of a protease that can cleave at the carboxyterminal side of proline residues offers an interesting option. Socalled prolyl oligopeptidases (EC 3.4.21.26) have the unique possibility of preferentially cleaving peptides at the carboxyl side of proline residues. In all adequately characterized proline specific proteases isolated from mammalian as well as microbial sources, a unique peptidase domain has been identified that excludes large peptides from the enzyme's active site. In fact these enzymes are unable to degrade peptides containing more than about 30 amino acid residues so that these enzymes are now referred to as “prolyl oligopeptidases” (Fulop et al: Cell, Vol. 94, 161-170, Jul. 24, 1998). As a consequence these prolyl oligopeptidases require an extensive pre-hydrolysis with other endoproteases before they can exert their hydrolytic action. However, as described in WO 02/45523, even the combination of a prolyl oligopeptidase with such another endoprotease results in hydrolysates characterized by a significantly enhanced proportion of peptides with a carboxyterminal proline residue. Because of this, such hydrolysates or fermented hydrolysates form an excellent starting point for the isolation of peptides with in vitro ACE inhibiting effects as well as an improved resistance to gastro-intestinal proteolytic degradation. Despite these potential benefits, we are not aware of an application specifying the use of proline specific proteases in conjunction with a fermentative process for the recovery of ACE inhibiting peptides let alone the selective production of the tripeptides IPP, VPP and LPP.

In the fermentation step many industrially utilized or commercially available dairy starter cultures and so called adjunct cultures can be used according to the present process. Lactic acid bacteria include members of the genera Lactobacillus, e.g. Lactobacillus helveticus, Lactobacillus plantarum, Lactobacillus rhamnosus and Lactobacillus delbrueckii ssp. bulgaricus, Lactococcus, e.g. Lactococcus lactis, Leuconostoc, Pediococcus and Streptocoocus. Microorganisms from the species Bifidobacterium and Lactobacillus are frequently used in probiotic preparations. The proteolytic system of lactic acid bacteria consists of a cell wall-bound endoproteinase and a number of distinct intracellular peptidases, including endopeptidases, and a large variety of amino-peptidases, including di-and tri-aminopeptidases. Quite surprisingly the lactic acid bacteria do not avail of carboxypeptidases. When used as starters in milk fermentation, the proteolytic system of lactobacilli hydrolyses the milk proteins hereby forming several kinds of peptides in the medium. Since these peptides are not all used by the bacteria for their growth, part of these peptides accumulate during fermentation. It is known, however, that the proteolytic capacity varies greatly among the various lactic acid bacteria (see for example Yamamoto at al., Biosci. Biotech. Biochem., 58 (4), 776-778, 1994). Lactobacillus helveticus, widely used as a dairy starter in the manufacture of traditional fermented milk products such as Emmental cheese, is known to possess relatively high proteolytic activity. The prior art refers to a number of highly proteolytic Lactobacillus helveticus strains such as CNRZ 244 (Centre National de recherches Zootechniques, Jouy-en-Josas, France), LKB-16H (U.S. Pat. No. 6,890,529), R211 and R389 (Institut Rossell, Montreal, Canada), CM4 (U.S. Pat. No. 6,534,304), JCM 1006 and JCM 1004 (Japanese Collection of Microorganisms, Saitama, Japan), CHCC637 and CHCC641 (Chr. Hansen Culture Collection, Horsholm, Denmark). To achieve acceptable levels of ACE-inhibitory peptides Lactobacillus helveticus strains may be required with exceptionally high proteolytic activities. The screening for such strains has been reported in number of publications. The best known ACE-inhibitory peptides, Val-Pro-Pro (VPP), Leu-Pro-Pro (LPP) and Ile-Pro-Pro (IPP), have been identified in milk fermented with such highly proteolytic Lactobacillus helveticus strains. Additionally the production of immuno-modulatory, anti-oxidative and anti-microbial peptides by such lactic acid bacteria have been described as well as the role of such lactic acid bacteria towards maintaining a healthy microflora on gastro-intestinal, mucosal surfaces (http://en.wikipedia.org/wiki/Lactic_acid bacteria). Bacteria belonging to the genera Lactobacillus and Bifidobacterium are also used as probiotics. Probiotics are defined as “live microorganisms which when administered in adequate amounts confer a health benefit on the host”. Therefore, a probiotic preparation should contain high numbers of viable microorganisms. In a preferred application according to the present invention, the added enzymatic activities are inactivated by a moderate heat treatment. As such a heat treatment will inactivate the microorganisms present as well, it is evident that for probiotic products or other products requiring high numbers of viable lactobacilli, the enzyme incubation is best carried out prior to the microbial fermentation. First, the enzymatic hydrolysis of the milk proteins is carried out under conditions such as, for example, mentioned in Example 3 of the present application. Then the enzymes are inactivated by a mild heat treatment, for example 2 to 7 seconds in a heat exchanger at 120 degrees C., where after the cooled and optionally filtered liquid can be inoculated with a suitable probiotic strain and grown until the high titers required for probiotic products, typically 10⁹ to 10¹⁰ colony forming units (CFU) per ml, have been reached. More detailed information on this approach can be found in Example 5 of the present application.

Although lactic acid bacteria produce a wide variety of proteases and highly proteolytic lactobacilli are used for the commercial production of blood pressure lowering peptides, we have found that supplementation with a proline-specific protease, optionally in combination with an aminopeptidase during the enzyme treatment phase of the process, further increases the yield of the ACE-inhibiting peptides IPP, VPP and LPP. Especially in fermentation process aimed at the generation of taste, texture of probiotic activities in which lactic acid bacteria or Bifidobacteria are used with limited proteolytic capacities, the supplementation with a proline-specific protease, optionally in combination with an aminopeptidase will lead to vastly enhanced levels of the ACE-inhibiting peptides. In one embodiment of the invention, the aminopeptidase is added simultaneously with the proline-specific protease, in another embodiment the incubation with the aminopeptidase is done separately of the incubation with the proline-specific protease. In general incubation with the aminopeptidase is preceded by an incubation with the proline-specific protease.

Milk fermentations, and especially milk fermentations using lactic acid bacteria having sub-optimal proteolytic activities, easily lead to bitter off-flavors as the result of partial protein hydrolysis. Proline-specific proteases as well as aminopeptidases have been described to minimize such bitter off-flavors. Thus, the use of these enzymes may not only lead to enhanced levels of ACE-inhibiting tripeptides but may advantageously also result in less bitter fermentation products. Such a possible reduction of the bitter taste may be shown in Example 5 of the present application.

The advantages of using a proline-specific protease according to the invention can be obtained by combining a fermentation of lactic acid bacteria or Bifidobacteria growing in a milk protein comprising broth, with an incubation of this broth with a proline-specific protease. The latter enzyme incubation can either precede the fermentation process or can take place during the fermentation process. Because of the very low pH optimum of the preferred proline-specific endoprotease, the enzyme incubation can even take place after the fermentation has taken place, i.e. in the fully acidified broth or in a fully acidified broth from which insoluble matter such as bacteria or clotted milk proteins have been removed. The enzyme incubation can even take place after an additional broth concentration step. In all such processes, the enzyme incubation may lead to a high and standardized level of ACE-inhibiting tripeptides. The process according to the invention has in general an enzyme incubation time of less than 24 hours, preferably the incubation time is less than 10 hours and more preferably less than 4 hours. If the enzyme incubation is done separate from the fermentation step, the incubation temperature is in general between 30° C. and 60° C., preferably higher than 30° C., more preferably higher than 40° C. and most preferably higher than 50° C.

The cultivation or fermentation time of the lactic acid bacteria or Bifidobacteria is in general between 3 and 30 hours, preferably between 6 and 16 hours. The cultivation or fermentation temperature is in general between 20 and 42° C., preferably between 25 and 38° C. In general at the start of the fermentation the pH of the protein containing broth is between 6 and 7. In general at the start of the fermentation there will be between preferably 10⁵ and 10⁹, more preferably between 10⁵ and 10⁷ cells of lactic acid bacteria (or Bifidobacterium) present per ml protein containing broth. These bacteria are usually obtained from a pre-incubation medium inoculated with the lactic acid bacteria (or Bifidobacterium) of choice. At the end of fermentation cell numbers are typically between 10⁸ and 10¹⁰ cells/ml are present. In the dairy industry socalled “starter” cultures are primarily responsible for the acidification of the milk. Typical examples of such starter cultures include Lactococcus lactis for cheese production and Streptococcus thermophilus and Lactobacillus delbruckii subspecies bulgaricus for traditional yogurts. Socalled “adjunct” cultures are used in the dairy industry to provide specific attributes to the end product such as flavour, texture or eye-formation. Typical examples of the latter cultures are Lactobacillus helveticus, Propionibacterium ssp and Lactobacillus acidophilus. Strains that are popular as probiotic cultures include Lactobacillus reuteri, Lactobacillus acidophilus, Lactobacillus rhamnosus and Bifidobacterium ssp. It is recommended that approximately 10⁹ viable cells of such probiotic cultures are consumed on a daily basis.

During the production of IPP and VPP, advantageously the ACE-inhibiting tripeptide LPP is also formed. Preferably at least 40%, more preferably at least 50%, or still more preferably at least 60% and most preferably at least 70% of -I-P-P- sequences present in the protein sequence of the milk product is converted into the tripeptide IPP. Preferably at least 40%, more preferably at least 50%, or still more preferably at least 60% and most preferably at least 70% of -V-P-P- sequences present in the protein sequence is converted into the tripeptide VPP. Preferably at least 40%, more preferably at least 50%, or still more preferably at least 60% and most preferably at least 70% of -L-P-P- sequences present in the protein sequence is converted into the tripeptide LPP. The proline specific protease is preferably capable of hydrolyzing large protein molecules like polypeptides as well as oligopeptides.

Apart from relating to a food product having blood pressure lowering activities, the present invention further relates to the use of these peptide compositions, for the manufacture of a nutraceutical, preferably a medicament, for the improvement of health or the prevention and/or treatment of diseases or for the manufacture of a nutraceutical preferably a medicament, for the treatment or prevention of high blood pressure (hypertension), heart failure, pre-diabetes or diabetes, obesity, renal failure, impaired blood flow circulation, impaired glucose tolerance or stress. Preferably the present peptide compositions are used in the form of a dietary supplement, in the form of a personal care application including a topical application in the form of a lotion, gel or an emulsion or as a food, beverage, feed or pet food ingredient.

The present invention further discloses
a peptide composition suitable for the treatment of hypertensive blood pressure obtained by an acid precipitation process and resulting in a peptide composition having a proline content of 15 to 30% (w/w), preferably higher than 18% (w/w), more preferably higher than 20% (w/w)on dry matter,
a peptide composition comprising
   5 to 20 mg/g VPP (on dry matter and on protein), 5 to 20 mg/g IPP (on dry matter and on protein) and optionally 5 to 20 mg/g LPP (on dry matter and on protein), and
a peptide composition comprising 15 to 50% (wt dry matter) peptides containing at least a carboxy terminal proline and which comprises at least 5 mg/g VPP (on dry matter and on protein), at least 5 mg/g IPP (on dry matter and on protein) and optionally at least 5 mg/g LPP (on dry matter and on protein).
   Furthermore the present invention relates to a process to produce a composition comprising soluble peptides which is produced by hydrolysing a protein with a proline specific proteases to a degree of hydrolysis (DH) of 5-38%. According to the present invention the process to obtain high amounts of the tripeptides IPP and VPP can be obtained preferably at a DH between 10 and 38, more preferably at a DH between 15 and 35 and most preferably at a DH between 20 and 30. The protein used in the present process is preferably a milk protein, more preferably casein or a caseinate. As sodium is known to play a role in hypertension, preferred substrates for the production of ACE inhibiting peptides are ammonia, calcium, magnesium and potassium rather than sodium salts of these proteins.

Advantageously the milk protein is not fermented before it is used in the present process and the enzymatic treatment may be carried out by combining the proline-specific protease with an aminopeptidase. Optionally the aminopeptidase is only added after the separation of the insoluble part of the hydrolysed protein. Preferably the insoluble part of the hydrolysed protein is separated from the soluble part under selected pH conditions.

In EP 1 231 279 a purely enzymatic process is described to recover the tripeptides VPP and IPP from milk casein. The application claims a method for producing tripeptides by digesting a material containing a milk casein with a proteinase and a peptidase via a so called “intermediate peptide” selected from the group consisting of a peptide containing a sequence Val-Pro-Pro but containing no Pro other than those in this sequence as well as a peptide containing a sequence Ile-Pro-Pro but containing no Pro other than those in this sequence. As described in the Examples of EP 1 231 279 the method involves a two-step process. First the intermediate peptides encompassing either Val-Pro-Pro or Ile-Pro-Pro are produced. This is done by incubating casein with a suitable proteinase according to one of the Examples, at 37 degrees C. for a 12 hours period. Then the proteinase used is inactivated by heating this first hydrolysate to 100 degrees C. for 3 minutes and, after cooling down again, another enzyme preparation (in fact a preparation with exoproteolytic activity) is added. After another 12 hours incubation at 37 degrees C. with this other enzyme preparation the presence of the tripeptides Val-Pro-Pro and Ile-Pro-Pro can be demonstrated. To obtain higher yields of these ACE inhibiting peptides, EP 1 231 279 further suggests to purify and concentrate the intermediate peptide prior to exposure to the exoproteolytic activity. EP 1 231 279 also suggests that after obtaining the intermediate peptide and before the intermediate peptide is contacted with the peptidase in the procedure various operations may optionally be performed such as the removal of the unreacted protein by e.g. centrifugation at 5000 to 20000 rpm for 3 to 10 minutes. So the desired tripeptides are obtained in an industrially rather unwieldy two-step enzymatic process. As each of the enzyme incubations may take as long as 12 hours at pH 4.5 to 7.0 and at the temperature of 25 to 50 degrees C., it is evident that this procedure is also unacceptable from a microbiological point of view. These long incubation times combined with low incubation temperature of 25 to 50° C. may easily result in infections of the protein containing solution. Thus according to the present invention bioactive peptides such as IPP and VPP are produced without purification of an intermediate product. EP 1231279 describes the formation of an intermediate peptide when milk protein is digested with a proteinase, which intermediate peptide contains no Pro other then the Ile-Pro-Pro or Val-Pro-Pro sequence, respectively. Subsequently, this intermediate peptide is converted with another enzyme to IPP or VPP, respectively. In order to obtain high yields, this intermediate peptide is chromatographically purified before converting to the tripeptide. According to the present invention high yields can be obtained without purifying an intermediate peptide.

In WO07/013426 a two-step process for producing the ACE-inhibiting peptides VPP, IPP and YP is described. In this approach the yield of the ACE inhibiting peptides is maximized by combining fermentation process by lactic acid bacteria with an enzyme incubation. This enzyme incubation can either precede the fermentation process or can be carried out simultaneously with the fermentation process. The enzymes of choice are papain, bromelain or a protease with a similar activity as papain or bromelain. Basically all these enzymes are so called cysteine proteases belonging to the the IUBMB class EC 3.4.22. Purpose of the incubation with this particular class of enzymes is to improve the decomposition of the milk proteins, hereby facilitating the formation of ACE-inhibiting peptides by the proteases produced by the lactobacilli. By comparing the final yields of IPP and VPP, these cysteine endoproteases were selected from a large number of other commercially available enzymes. Cysteine endoproteases are known for their broad cleavage specificity but have a preference for cleaving C-terminal (“behind”) the amino acid residues Arg, Lys, Phe and Tyr (see Adler-Nissen, J. In Enzymatic Hydrolysis of Food Proteins, first edition; Adler-Nissen, J., Ed., Elsevier Appl. Sci Publ., London, UK, 1986). Important to note is that, unlike the proline-specific proteases according to the invention, these cysteine endoproteases have no or only a negligible capacity to cleave proteins or peptides C-terminal of proline residues. Vice versa, unlike the cysteine endoproteases, the proline-specific proteases according to the invention display a negligible preference for cleaving C-terminal of the Arg, Lys, Phe and Tyr residues. Thus, the process according to the present invention hinges on the activity of a proline-specific endo activity, be it a proline-specific oligopeptidase with a neutral pH optimum or a proline-specific endoprotease with an acid pH optimum. In both cases additionally an aminopeptidase can be used. The pH optimum of the A. niger derived proline-specific endoprotease is around 4.3. Because of this low pH optimum incubating bovine milk caseinate with the A. niger derived prolyl endoprotease is not self-evident. On the one hand bovine milk caseinate will precipitate if the pH drops below 6.0, i.e. at pH values at which the proline-specific endoprotease can deploy its full activity the substrate is precipitated and not easily accessible; on the other hand, at pH values above 6.0 the proline-specific endoprotease can be expected to be partly destabilized and only marginally active. Here we show that under both rather unfavourable, conditions an incubation with the A. niger derived proline-specific endoprotease may yield several ACE inhibiting peptides or precursors thereof. According to the present invention the ACE inhibiting tripeptides IPP and LPP are each produced in yields that correspond with at least 30%, advantageously at least 40%, more advantageously at least 50% of the amount theoretically present in casein. Another aspect of the present invention is a process to concentrate the ACE inhibitory peptides from the milk protein hydrolysate. Unlike the approach followed in WO07/013426, such a milk protein hydrolysate is preferably hydrolysed by a non-cysteine protease, more preferably by a serine protease, even more preferably by a proline-specific protease. A cysteine endopeptidase is understood to incorporate all enzymes belonging to the IUBMB class EC 3.4.22. Part of the milk protein hydrolysed by the proline-specific protease according to the invention will precipitate under selected pH conditions. The concentration process comprises removing the partly precipitated hydrolysed protein from the fermentation broth thus separating the precipitated proteins from the ACE inhibitory peptides in solution. In a further embodiment efficient and convenient recovery of the ACE inhibitory peptides the pH value of the fermented broth is adjusted to a more neutral pH value in order to partly redissolve the casein precipitate formed hereby improving the accessibility of the proline-specific protease and increasing the efficacy of the optionally added aminopeptidase. As demonstrated in the present application, both effects leading to increased yields of the ACE-inhibitory tripeptides. To further optimize the resulting fermentation liquid for treating individuals suffering from too high a blood pressure, during the subsequent processing any remaining undissolved matter may be removed, followed by a treatment such as nanofiltration to remove small molecules such as mono saccharides, lactic acid, sodium and chloride. If desired, the retentate of the nanofiltration can be topped up with blood pressure lowering ions such as calcium, potassium and magnesium.

Although the same principle, fermentation combined with enzymatic treatment, is used in the cheese making process for separating casein curd from whey proteins and cheese ripening, in the cheese making process use is made of aspartic endoproteases (EC 3.4.23) only. This enzyme class incorporates well known cheese making enzymes like chymosin and various pepsins like the mammalian pepsins as well as various microbial pepsins like aspergillopepsins and mucorpepsins. In the present application curd production in the cheese making process or the cheese making is defined not to be comprised by the process of the invention.

Preferably the proline-specific protease is free from contaminating endoprotease activity. Optionally an aminopeptidolytic activity is present in combination with the proline specific protease and VPP as well as IPP can be produced in an almost 100% yield. Preferably the aminopeptidolytic activity is also free from contaminating endoprotease activity.

The present invention relates to a hydrolysate or peptide containing composition for use as a food product or as a concentrate that can be added to a food product to obtain the desired level of ACE-inhibiting activity in such a food product. Alternatively, the hydrolysate or peptide containing composition according to the invention is used as a nutraceutical, preferably a medicament. The invention also relates to the use of the present hydrolysate or peptide containing composition as a nutraceutical preferably a medicament, to the use of the present hydrolysate or peptide containing composition for the manufacture of a nutraceutical preferably a medicament, to the use of the present hydrolysate or peptide containing composition for the improvement of health or the prevention and/or treatment of diseases, to the use of the present hydrolysate or peptide containing composition for the manufacture of a nutraceutical preferably a medicament, to the use of the present hydrolysate or peptide containing composition for the treatment or prevention of cardiovascular diseases such as hypertension and heart failure, to the use of the present hydrolysate or peptide containing composition for the treatment or prevention of renal failure, to the use of the present hydrolysate or peptide containing composition wherein the present hydrolysate or peptide containing composition is in the form of a dietary supplement, to the use of the present hydrolysate or peptide containing composition for the manufacture of a functional food product for the therapeutic treatment of the effects of stress, to the use of the present hydrolysate or peptide containing composition in topical application preferably in personal care application and to the use of the present hydrolysate or peptide containing composition in feed and pet food.

Furthermore the present invention relates to a method of treatment of type 1 and 2 diabetes, and for the prevention of cardiovascular complications that are frequently associated with type 2 diabetes, individuals with pre-diabetes, or impaired glucose tolerance (IGT) which comprises administering to a subject in need of such treatment the present hydrolysate or peptide containing composition and to a method of treatment of people that suffer of hypertension or heart failure or the prevention thereof which comprises administering to a subject in need of such treatment the present hydrolysate or peptide containing composition and thus, exhibit blood pressure lowering effects. Inhibition of ACE results in reduced vasoconstriction, enhanced vasodilation, improved sodium and water excretion, which in turn leads to reduced peripheral vascular resistance and blood pressure and improved local blood flow. Thus, the present bioactive peptides, comprising peptide, are particularly efficacious for the prevention and treatment of diseases that can be influenced by ACE inhibition, which include but are not limited to hypertension, heart failure, angina pectoris, myocardial infarction, stroke, peripheral arterial obstructive disease, atherosclerosis, nephropathy, renal insufficiency, erectile dysfunction, endothelial dysfunction, left ventricular hypertrophy, diabetic vasculopathy, fluid retention, and hyperaldosteronism.

It is generally recognised that stress-related diseases, and the negative effects of stress upon the body, have a significant impact upon many people. In recent years the effects of stress, and its contribution towards various the development of various diseases and conditions, has gained wider acceptance in the medical and scientific community. Consumers are now becoming increasingly aware of these potential problems and are becoming increasingly interested in reducing or preventing the possible negative impact of stress on their health. Therefore, it is a further object of the invention to provide a food product, or an ingredient which can be incorporated therein, which is suitable for use in helping the body deal with the effects of stress. It is a further object to provide a food product comprising the present hydrolysate or peptide containing composition which provides a health benefit, such as helping the body deal with the negative effects of stress.

The term nutraceutical as used herein denotes the usefulness in both the nutritional and pharmaceutical field of application. Thus, the novel nutraceutical compositions can find use as supplement to food and beverages, and as pharmaceutical formulations or medicaments for enteral or parenteral application which may be solid formulations such as capsules or tablets, or liquid formulations, such as solutions or suspensions. As will be evident from the foregoing, the term nutraceutical composition also comprises food and beverages comprising the present hydrolysate or peptide containing composition and optionally carbohydrate as well as supplement compositions, for example dietary supplements, comprising the aforesaid active ingredients.

The term dietary supplement as used herein denotes a product taken by mouth that contains a “dietary ingredient” intended to supplement the diet. The “dietary ingredients” in these products may include: vitamins, minerals, herbs or other botanicals, amino acids, and substances such as enzymes, organ tissues, glandulars, and metabolites. Dietary supplements can also be extracts or concentrates, and may be found in many forms such as tablets, capsules, soft gels, gel caps, liquids, or powders. They can also be in other forms, such as a bar, but if they are, information on the label of the dietary supplement will in general not represent the product as a conventional food or a sole item of a meal or diet.

A multi-vitamin and mineral supplement may be added to the nutraceutical compositions of the present invention to obtain an adequate amount of an essential nutrient missing or known to be relatively low in some diets. The multi-vitamin and mineral supplement may also be useful for disease prevention and protection against nutritional losses and deficiencies due to lifestyle patterns and common inadequate dietary patterns sometimes observed in diabetes. Moreover, oxidant stress has been implicated in the development of insulin resistance. Reactive oxygen species may impair insulin stimulated glucose uptake by disturbing the insulin receptor signalling cascade. The control of oxidant stress with antioxidants such as α-tocopherol (vitamin E) ascorbic acid (vitamin C) may be of value in the treatment of diabetes. Therefore, the intake of a multi-vitamin supplement may be added to the above mentioned active substances to maintain a well balanced nutrition.

Furthermore, the combination of the present hydrolysate or peptide containing composition with minerals such as magnesium (Mg²⁺), Calcium (Ca²⁺) and/or potassium (K⁺) may be used for the improvement of health and the prevention and/or treatment of diseases including but not limited to cardiovascular diseases and diabetes.

In a preferred aspect of the invention, the nutraceutical composition of the present invention contains the present hydrolysate or peptide containing compositions. Both IPP and VPP are suitably is present in the composition according to the invention in an amount to provide a daily dosage from about 0.001 g per kg body weight to about 1 g per kg body weight of the subject to which it is to be administered. A food or beverage suitably contains about 0.05 g per serving to about 50 g per serving of IPP and VPP, respectively. If the nutraceutical composition is a pharmaceutical formulation such formulation may contain IPP and VPP, respectively, in an amount from about 0.001 g to about 1 g per dosage unit, e.g., per capsule or tablet, or from about 0.035 g per daily dose to about 70 g per daily dose of a liquid formulation. The present hydrolysate or peptide containing composition suitably is present in the composition according to the invention in an amount to provide a daily dosage from about 0.01 g per kg body weight to about 3 g per kg body weight of the subject to which it is to be administered. A food or beverage suitably contains about 0.1 g per serving to about 100 g per serving of bioactive peptides. If the nutraceutical composition is a pharmaceutical formulation such formulation may contain the hydrolysate or peptide containing composition in an amount from about 0.01 g to about 5 g per dosage unit, e.g., per capsule or tablet, or from about 0.7 g per daily dose to about 210 g per daily dose of a liquid formulation.

In yet another preferred aspect of the invention a composition comprises the present peptides as specified above and optionally carbohydrates. Carbohydrates suitably are present in the composition according to the invention in an amount to provide a daily dosage from about 0.01 g per kg body weight to about 7 g per kg body weight of the subject to which it is to be administered. A food or beverage suitably contains about 0.5 g per serving to about 200 g per serving of carbohydrates. If the nutraceutical composition is a pharmaceutical formulation such formulation may contain carbohydrates in an amount from about 0.05 g to about 10 g per dosage unit, e.g., per capsule or tablet, or from about 0.7 g per daily dose to about 490 g per daily dose of a liquid formulation.

Dosage ranges (for a 70 kg person)

VPP and IPP: 0.005-70 g/day (each)

bioactive peptides composition: 0.07-210 g/day

Unhydrolysed proteins: 0.07-210 g/day

Carbohydrates: 0.1-490 g/day

It is an object of the invention to provide an edible material which can be used to provide health benefits to a subject consuming it. It is yet a further object to provide such an edible material which can conveniently be ingested either in isolated form or incorporated into a food product.

It is a further object of the invention to provide a food product, or an ingredient which can be incorporated therein, which is suitable for use in body weight control programmes.

It is a further object of the invention to provide a food product, or an ingredient which can be incorporated therein, which is suitable for helping to maintain cardiovascular health, e.g. through ACE inhibition.

It is a further object of the invention to provide a food product, or an ingredient which can be incorporated therein, which have acceptable stability and/or organoleptic properties, in particular good taste, such as an absence of or an acceptable level of bitterness.

It is a further object to provide a food product having a high concentration of an ingredient which provides a health benefit, such as aiding the prevention of obesity/body weight control and/or helping maintain cardiovascular health.

Surprisingly, one or more of these objects is attained according to the invention by the use of the present hydrolysate or peptide containing composition for the preparation of a food product which provides a health benefit upon consumption.

According to a first aspect the present invention provides the use of the present hydrolysate or peptide containing composition for the manufacture of a functional food product for the prevention of obesity or body weight control.

According to a second aspect the present invention provides the use of the present hydrolysate or peptide containing composition for the manufacture of a functional food product for cardiovascular health maintenance.

It is especially preferred according to the present invention that cardiovascular health maintenance comprises the inhibition of angiotensin-converting (ACE) enzyme and/or the control of blood glucose levels.

According to a third aspect the present invention provides a functional food product capable of providing a health benefit to the consumer thereof, said health benefit selected from the prevention of obesity, body weight control and cardiovascular health maintenance and comprising the present hydrolysate or peptide containing composition.

A further advantage of the hydrolysate or peptide containing composition according to the present invention is that this hydrolysate or peptide containing composition can be conveniently incorporated into food products, to produce, functional food products, without unacceptably affecting the stability and/or organoleptic properties thereof.

“Health benefit agent(s)” according to the present invention are materials which provide a health benefit, that is which have a positive effect on an aspect of health or which help to maintain an aspect of good health, when ingested, these aspects of good health being prevention of obesity, body weight control and cardiovascular health maintenance. “Health benefit” means having a positive effect on an aspect of health or helping to maintain an aspect of good health.

“Functional food products” according to the present invention are defined as food products (including for the avoidance of doubt, beverages), suitable for human consumption, in which the hydrolysate or peptide containing composition of the present invention is used as an ingredient in an effective amount, such that a noticeable health benefit for the consumer of the food product is obtained.

The term “comprising” where used herein is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

The product of the process of the present invention can be used as such, or as ingredient of a neutraceutical or nutritional product, optionally after drying.

To another aspect of the invention, the product of the present process can be further concentrated or purified. The product can for example be slowly acidified to realise a pH drop to 4.5 or at least below 5.0. At this pH value all large peptides from the protein substrate such as caseinate, will precipitate so that only the smaller peptides remain in solution. Preferably the acidified mixture is kept at a low temperature for several hours to precipitate as much proteins and large peptides as possible. As the precipitated peptides and proteins can be easily removed by decantation or a filtration step or a low speed (i.e. below 5000 rpm) centrifugation, the aqueous phase contains a high proportion of bioactive peptides relative to the amount of protein present. According to Kjeldahl data 80 to 70% of the protein is removed by the low speed centrifugation step which implies a four- to five-fold purification of the bioactive peptides. Optionally the purification can be further improved by a subsequent ultra filtration step.

In nutraceutical applications and food and beverage applications, products of the inventions are advantageously used. The bioactive peptides, an acid-soluble fraction thereof as well as an mixture thereof can be used in a nutraceutical application, a food application or a beverage. Preferably the acid-soluble bioactive peptides are used in a nutraceutical application, a food application or a beverage because of the high content of active peptides present.

After decantation, filtration or low speed centrifugation to remove the precipitate formed during the fermentation process, the supernatants containing the biologically active peptides can be recovered. A subsequent evaporation, optionally in combination with an additional filtration step followed by a spray drying step will yield an economical route for obtaining a food grade paste or powder with a high bio-activity and a good water solubility.

The bioactive peptides as obtained either before or after an additional concentration step may be used as such or may be used for the incorporation into food products that are widely consumed on a regular basis. Examples of such products are margarines, spreads, various dairy products such as butter or yoghurts or milk or whey containing beverages, preferably yoghurt or milk based products such as yoghurt and milk. Also in other beverages such as fruit drinks or soy drinks or even mineral waters or shots, the bioactive peptides of the present invention can be used. Another option is the use of the bioactive peptides in health products such as fruit bars, protein bars, energy bars, cereal based products for example breakfast cereals. Preferably the food or beverage product or dietary supplement is selected from the group of margarines, spreads, butter, dairy products or whey containing beverages, preferably yoghurt or milk based products such as yoghurt or milk, wherein said food or beverage product or dietary supplement comprises the amounts of bioactive peptides as indicated above.

Especially preferred are food or beverage products or dietary supplements as described here above for use to relief hypertension of human beings. Preferred serving sizes for the food or beverage or dietary supplements are for example 5-350 grams per serving, for example from 5 to 150 grams. Preferably the number of servings per day is 1-10, for example 2 to 5.

Although such compositions are typically administered to human beings, they may also be administered to animals, preferably mammals, to relief hypertension.

Furthermore the high concentration of bioactive peptides in the products as obtained makes these products very useful for the incorporation into dietary supplements in the form off pills, tablets or highly concentrated solutions or pastes or powders. Slow release dietary supplements that will ensure a continuous release of the bioactive peptides are of particular interest. The bioactive peptides according to the invention may be formulated as a dry powder in, for example, a pill, a tablet, a granule, a sachet or a capsule. Alternatively the bioactive peptides according to the invention may be formulated as a liquid in, for example, a syrup or a capsule. The compositions used in the various formulations and containing the bioactive peptides according to the invention may also incorporate at least one compound of the group consisting of a physiologically acceptable carrier, adjuvant, excipient, stabiliser, buffer and diluant which terms are used in their ordinary sense to indicate substances that assist in the packaging, delivery, absorption, stabilisation, or, in the case of an adjuvant, enhancing the physiological effect of the enzymes. The relevant background on the various compounds that can be used in combination with the enzymes according to the invention in a powdered form can be found in “Pharmaceutical Dosage Forms”, second edition, Volumes 1, 2 and 3, ISBN 0-8247-8044-2 Marcel Dekker, Inc. Although the ACE inhibiting peptides according to the invention formulated as a dry powder can be stored for rather long periods, contact with moisture or humid air should be avoided by choosing suitable packaging such as for example an aluminum blister. A relatively new oral application form is the use of various types of gelatin capsules or gelatin based tablets.

In view of the relevance of natural ACE inhibiting peptides to fight hypertension the present new and cost effective route offers an attractive starting point for mildly hypotensive alimentary or even veterinary products.

The process according to the invention can be accomplished using any proline specific oligopeptidase or endoprotease. By proline-specific oligopeptidases according to the invention or used according to the invention are meant the enzymes belonging to EC 3.4.21.26. By the proline-specific endo protease according to the invention or used according to the invention is meant the polypeptide as mentioned in claims 1-5, 11 and 13 of WO 02/45524. Preferably the polypeptide is in isolated form.

The process according to the invention can be accomplished using any aminopeptidolytic enzyme preparation that can release valine (“V”) residues as well as glutamine (“Q”) and asparagine (“N”) residues. A suitable assay for measuring such enzymatic activities is specified in Example 12 of WO 2006/005757. Preferably the aminopeptidolytic activity is obtained from Aspergillus species.

The strains of the genus Aspergillus have a food grade status and enzymes derived from these micro-organisms are known to be from an non suspected, food grade source. According to another preferred embodiment, the enzyme is secreted by its producing cell rather than a non-secreted, so called cytosolic enzyme. In this way enzymes can be recovered from the cell broth in an essentially pure state without expensive purification steps. Preferably the enzyme has a high affinity towards its substrate under the prevailing pH and temperature conditions.

### DESCRIPTION OF THE FIGURES

FIG. 1. Increase of the IPP concentration in fermented skim milk under conditions as described in Example 2. The horizontal axis indicates the incubation period in hours with the proline-specific endoprotease after the fermentation period. The units indicated refer to PPU's/g milk protein.

FIG. 2. Increase of the LPP concentration in fermented skim milk under conditions as described in Example 2. The horizontal axis indicates the incubation period in hours with the proline-specific endoprotease after the fermentation period. The units indicated refer to PPU's/g milk protein.

FIG. 3. Release of IPP from a caseinate solution under conditions as described in Example 3. The horizontal axis indicates the incubation period in hours with the proline-specific endoprotease. The vertical axis provides the IPP concentration in micrograms/ml incubation liquid. The units indicated refer to PPU's/g milk protein.

FIG. 4. Release of LPP from a caseinate solution under conditions as described in Example 3. The horizontal axis indicates the incubation period in hours with the proline-specific endoprotease. The vertical axis provides the LPP concentration in micrograms/ml incubation liquid. The units indicated refer to PPU's/g milk protein.

FIG. 5. Release of IPP from a GMP solution under conditions as described in Example 3. The horizontal axis indicates the incubation period in hours with the proline-specific endoprotease. The vertical axis provides the IPP concentration in micrograms/ml incubation liquid. The units indicated refer to PPU's/g milk protein.

### MATERIALS AND METHODS

Potassium caseinate was obtained from DMV International (The Netherlands), glycomacropeptide (“Bio-PURE GMP”) from Davisco Foods International, Inc.(US). UHT skim milk, Yakult and Vifit products (the latter two from Yakult, The Netherlands and Campina, The Netherlands respectively) were obtained from a local supermarket. Aminopeptidase Corolase LAP Ch.: 4123 (“LAP”) was obtained from AB Enzymes (UK), preparation Peptidase 436P (“P436P”) which is high in aminopeptidase activity was obtained from Biocatalysts Ltd, Wales, UK). Overproduction of the aminopeptidase “ZBH” is described in W0.02/068623 and WO 98/46772. Its chromatographic purification was achieved by anion exchange chromatography on Q-sepharose FF XK followed by cation chromatography on SP-Sepharose XK. Overproduction of the proline specific endoprotease from Aspergillus niger (“PSE”) and its chromatographic purification was accomplished as described in WO 02/45524. The activity of the latter enzyme was tested on the synthetic peptide Z-Gly-Pro-pNA at 37 degrees C. in a citrate/disodium phosphate buffer pH 4.6. The reaction product was monitored spectrophotometrically at 405 nM. One unit (PPU) is defined as the quantity of enzyme that liberates 1 μmol of p-nitroanilide per minute under these test conditions. One PPU of proline-specific endoprotease from A. niger corresponds to 10 mg of enzyme protein.

Kjeldahl Nitrogen

Total Kjeldahl Nitrogen was measured by Flow Injection Analysis. Using a Tecator FIASTAR 5000 Flow Injection System equipped with a TKN Method Cassette 5000-040, a Pentium 4 computer with SOFIA software and a Tecator 5027 Autosampler the ammonia released from protein containing solutions was quantitated at 590 nm. A sample amount corresponding with the dynamic range of the method (0.5-20 mg N/I) is placed in the digestion tube together with 95-97% sulphuric acid and a Kjeltab subjected to a digestion program of 30 minutes at 200 degrees C. followed by 90 minutes at 360 degrees C. After injection in the FIASTAR 5000 system the nitrogen peak is measured from which the amount of protein measured can be inferred.

Amino Acid Analysis

A precisely weighed sample of the proteinaceous material was dissolved in dilute acid and precipitates were removed by centrifugation in an Eppendorf centrifuge. Amino acid analysis was carried out on the clear supernatant according to the PicoTag method as specified in the operators manual of the Amino Acid Analysis System of Waters (Milford Mass., USA). To that end a suitable sample was obtained from the liquid, then dried and subjected to vapour phase acid hydrolysis and derivatised using phenylisothiocyanate. The various derivatised amino acids present were quantitated using HPLC methods and added up to calculate the total level of free amino acids in the weighed sample. The amino acids Cys and Trp are not included in the data obtained in this analysis.

LC/MS/MS Analysis

HPLC using an ion trap mass spectrometer (Thermoquest®, Breda, the Netherlands) coupled to a P4000 pump (Thermoquest®, Breda, the Netherlands) was used in quantification of the peptides of interest, among these the tripeptides IPP, LPP and VPP, in the enzymatic protein hydrolysates produced by the inventive enzyme mixture. The peptides formed were separated using a Inertsil 3 ODS 3, 3 mm, 150*2.1 mm (Varian Belgium, Belgium) column in combination with a gradient of 0.1% formic acid in Milli Q water (Millipore, Bedford, Mass., USA; Solution A) and 0.1% formic acid in acetonitrile (Solution B) for elution. The gradient started at 100% of Solution A, kept here for 5 minutes, increasing linear to 5% B in 10 minutes, followed by linear increasing to 45% of solution B in 30 minutes and immediately going to the beginning conditions, and kept here 15 minutes for stabilization. The injection volume used was 50 microliters, the flow rate was 200 microliter per minute and the column temperature was maintained at 55° C. The protein concentration of the injected sample was approx. 50 micrograms/milliliter.

Detailed information on the individual peptides was obtained by using dedicated MS/MS for the peptides of interest, using optimal collision energy of about 30%. Quantification of the individual peptides was performed using external calibration, by using the most abundant fragment ions observed in MS/MS mode.

The tripeptide LPP (M=325.2) was used to tune for optimal sensitivity in MS mode and for optimal fragmentation in MS/MS mode, performing constant infusion of 5 mg/ml, resulting in a protonated molecule in MS mode, and an optimal collision energy of about 30% in MS/MS mode, generating a B- and Y-ion series.

Prior to LC/MS/MS the enzymatic protein hydrolysates or bioactive peptide compositions were centrifuged at ambient temperature and 13000 rpm for 10 minutes, filtered through a 0.22 μm filter and the supernatant was diluted 1:100 with MilliQ water.

Degree of Hydrolysis

The Degree of Hydrolysis (DH) as obtained during incubation with the various protolytic mixtures was monitored using a rapid OPA test (Nielsen, P. M.; Petersen, D.; Dambmann, C. Improved method for determining food protein degree of hydrolysis. Journal of Food Science 2001, 66, 642-646). The degree of hydrolysis is a measure for the extent to which peptide bonds are broken by the enzymatic hydrolysis reaction.

### Examples

### Example 1

### Release of Blood Pressure Lowering Tripeptides by Incubating Skim Milk with a Proline-specific Protease Optionally in Combination with a Lactobacillus Fermentation

To test the effect of the proline-specific endoprotease from Aspergillus niger on the release of the known blood pressure lowering peptides IPP, VPP and LPP, skim milk was incubated under six different conditions. In the first set of three experiments, skim milk was incubated as such with the proline-specific endoprotease and with a combination of the proline-specific endoprotease and a pure aminopeptidase. In the second set of three experiments, the skim milk was first incubated at 37 degrees C. with a highly proteolytic Lactobacillus helveticus strain (LKB-16H) and then, when the pH was lowered to approx 5.7, either the proline-specific endoprotease or the combination of the proline-specific endoprotease and the pure aminopeptidase was added and the incubations were pursued with shaking for another 24 hours. In all these experiments a relatively high enzyme concentration was used to prevent that too low a dosage of the enzyme leads to the conclusion that the enzyme addition has no effect. After terminating the enzyme reactions, the coagulated reaction mixtures were centrifuged and the supernatant was filtered prior to quantification of the tripeptides by LC/MS (see Materials & Methods). The beneficial effect of adding the aminopeptidase is explained in WO2006/005757. Briefly, bovine milk casein incorporates a number of different proteins including beta-casein and kappa-casein. According to the known amino sequences, beta-casein encompasses the ACE inhibitory tripeptides IPP, VPP and LPP. In beta-casein IPP is contained in the sequence -P₇₁-Q₇₂-N₇₃-I₇₄-P₇₅-P₇₆-, VPP is contained in the sequence -P₈₁-V₈₂-V₈₃-V₈₄-P₈₅-P₈₆- and LPP is contained in the sequence -P₁₅₀-L₁₅₁-P₁₅₂-P₁₅₃-. Kappa-casein, which is present in acid precipitated caseinate preparations in a molar concentration of almost 50% of the beta-casein concentration, encompasses IPP only. In kappa-casein IPP is contained in the sequence -A₁₀₇-I₁₀₈-P₁₀₉-P₁₁₀-. As proline-specific endoprotease can cleave peptide bonds at the C-terminal of proline and alanine (but not within P-P sequences), the incubation of skim milk with proline-specific endoprotease releases IPP from kappa-caseine as well as LPP from beta-caseine. Additionally the pentapeptides QNIPP and VVVPP, incorporating IPP and VPP respectively, are generated from beta-caseine. To release IPP and VPP from these pentapeptides, aminopeptidase activity is required. Theoretically this aminopeptidase activity can be provided by lysed lactobacilli generated during the fermentation process. However, such aminopeptidase activity can be too low so that, according to the present invention, the activity can be provided as an external enzyme. In the present experiment this aminopeptidase activity is provided in the form of the commercial product Corolase LAP.

As can be seen in Table 1, in the incubations without Lactobacillus helveticus, the combination of the proline-specific endoprotease and the aminopeptidase leads to the highest levels of the three blood pressure lowering tripeptides. Also in the presence of the Lactobacillus helveticus strain, the IPP, LPP and VPP levels are highest in combination with additional endoprotease and the aminopeptidase added. The fact that the presence of the Lactobacillus helveticus strain topped up with extra proline-specific endoprotease and aminopeptidase leads to the highest levels of the three blood pressure lowering tripeptides, shows that the proteolytic enzyme activity as provided by the highly proteolytic Lactobacillus helveticus strain alone, is inadequate to maximize the yield of the blood pressure lowering tripeptides during milk fermentations.

TABLE 1
Concentration of blood pressure lowering
tripeptides in mg/g milk protein

| | | No enzyme | | PSE + aminopeptidase |
|---|---|---|---|---|
| | Peptide | added | PSE added | added |
| Skim milk | IPP | 0.0 | 0.11 | 0.18 |
| | VPP | 0.0 | 0.05 | 0.56 |
| | LPP | 0.0 | 0.09 | 0.10 |
| Skim milk + | IPP | 0.01 | 0.10 | 0.29 |
| lactobacilli | VPP | 0.04 | 0.05 | 1.13 |
| | LPP | 0.0 | 0.19 | 0.26 |

PSE = proline-specific endoprotease from A. niger in a concentration of 4 PPU/g protein present
Aminopeptidase = Corolase LAP Ch.: 4123 (AB Enzymes, UK) in a concentration of 125 microliter/g protein present

### Example 2

### Effect of Adding a Proline-Specific Endoprotease After Completion of the Lactobacillus Fermentation

As shown in Example 1, the proteolytic activities that become available during fermentation with a highly proteolytic Lactobacillus helveticus strain are in fact insufficient to liberate the blood pressure lowering tripeptides from milk with a high efficiency. Also shown in Example 1 is that the addition of a proline-specific endoprotease, or preferably the combination of a proline-specific endoprotease plus a suitable aminopeptidase, could compensate for this. The latter enzymes can be added before, during or after the fermentation process in order to enhance the yield of the blood pressure lowering tripeptides and to obtain a reproducible end product (see Examples 4 and 5). The present Example illustrates the effect of adding a proline-specific endoprotease after completion of the fermentation process.

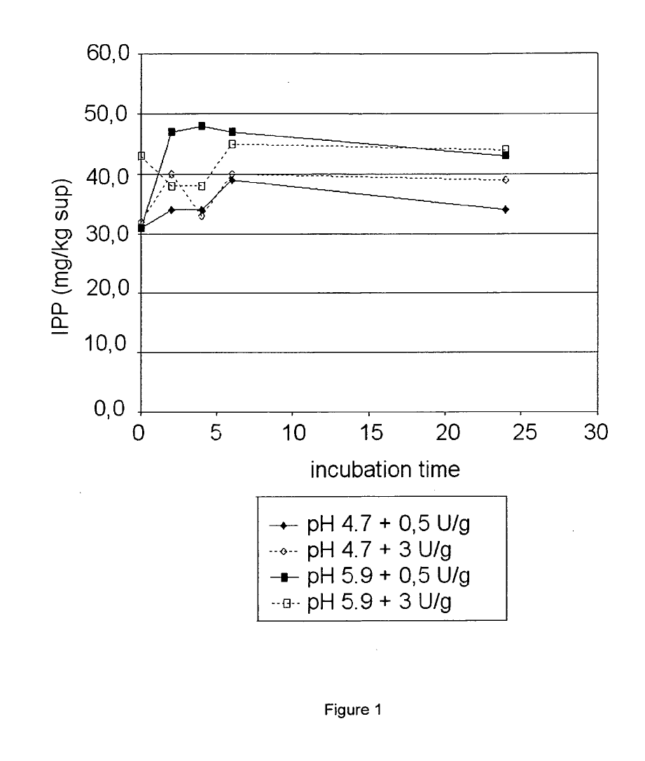

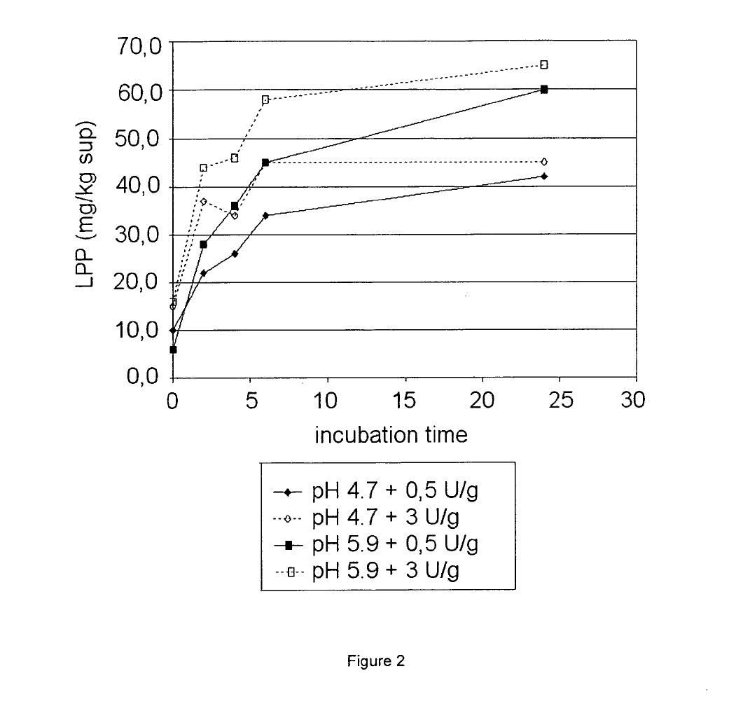

After finalizing the skim milk fermentation at 37 degrees C., the resulting acidified milk product was first heat-treated to kill the lactobacilli present and, after that, the pH of the suspension was raised to either 4.7 or 5.9 by adding KOH. The pH 5.9 adjustment was incorporated to test if higher pH conditions during the subsequent enzyme incubation, would facilitate the dissolution of the many casein clots formed as a result of the acidification of the milk during fermentation. After the pH adjustments, the proline-specific endoprotease from A. niger was added in a concentration of either 0.5 or 3.0 PPU/g milk protein and incubation was pursued at 50 degrees C. for either 2, 4, 6 or 23 hours. At the end of each incubation period the endoprotease was inactivated by a heat treatment for 10 minutes at 95 degrees C. and the insoluble materials were removed by centrifugation. In the clear supernatants, the concentration of the blood pressure lowering tripeptides IPP and LPP were measured according to the LC/MS procedure described in the Materials & Methods section. From the results (see FIGS. 1 and 2) it can be concluded that, as a result of the enzyme incubation, the yield of especially LPP (FIG. 2) significantly increases. The fact that the incubations with the highest pH values lead to the highest LPP yields, suggests that indeed dissolution of casein clots and not an increased enzyme activity play a role as the proline-specific enzyme is less active at such relatively high pH values. Similar, but less extreme, observations were made for IPP production (FIG. 1). The data obtained also illustrate that although a high enzyme dosage (3 PPU/g milk protein) leads to higher LPP and IPP yields, the difference with an almost ten times lower enzyme dosage (0.5 PPU/g milk protein) is marginal so that it may be more cost effective to use low enzyme dosages.

### Example 3

### Enzyme Dosages Required to Release Maximal Levels of Blood Pressure Lowering Peptides from Caseinate and Glycomacropeptide

An advantage of the invention detailed in the present application is that a variety of products can be made starting from different milk protein containing products and using different fermentative strains yielding the maximal amounts of blood pressure lowering peptides from the milk protein present. For obtaining the best results in terms of peptide yield, the enzyme dosage has to be optimized for the type of substrate and fermentation process used. However, once optimized, a highly reproducible production process is obtained in which low levels of exogeneous enzyme suffice for generating the highest amounts of blood pressure lowering peptides. The enzyme dosages required to generate maximal IPP, VPP and LPP levels from skim milk are indicated in Examples 1 and 2. The present Example shows the enzymatic release of the relevant blood pressure lowering peptides from potassium caseinate as well as glycomacropeptide.and illustrates the enzyme/milk protein ratios required to optimize peptide yields. The blood pressure lowering peptides that are theoretically present in each of these substrates were mentioned in Example 1. Glycomacropeptide (GMP) is the soluble fragment that is released from kappa-casein after cleavage with chymosin and incorporates a single IPP sequence (I₁₀₈-P₁₀₉-P₁₁₀). In order to focus on the effect of the added enzymes, in this experiment the caseinate and GMP solutions were not inoculated with a microorganism so that no fermentation took place.

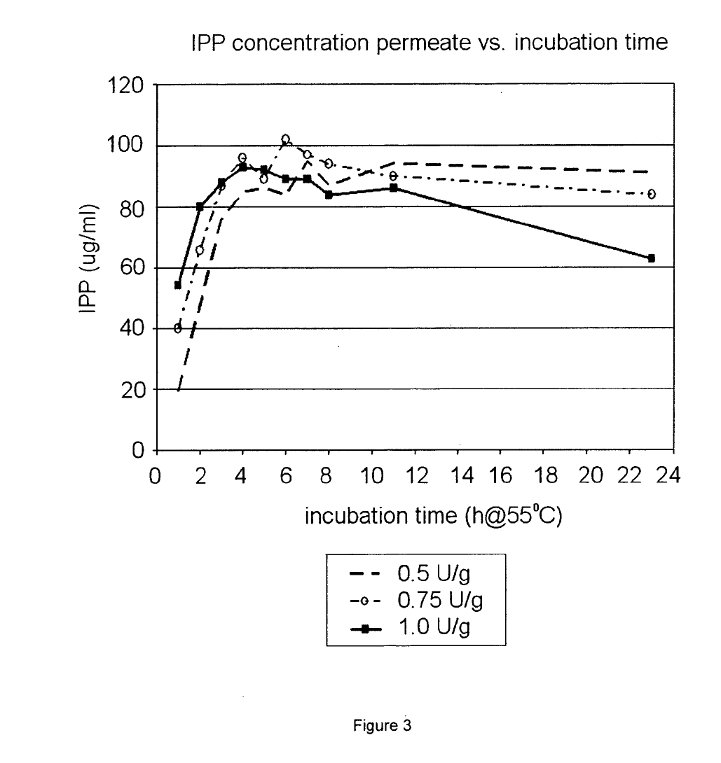

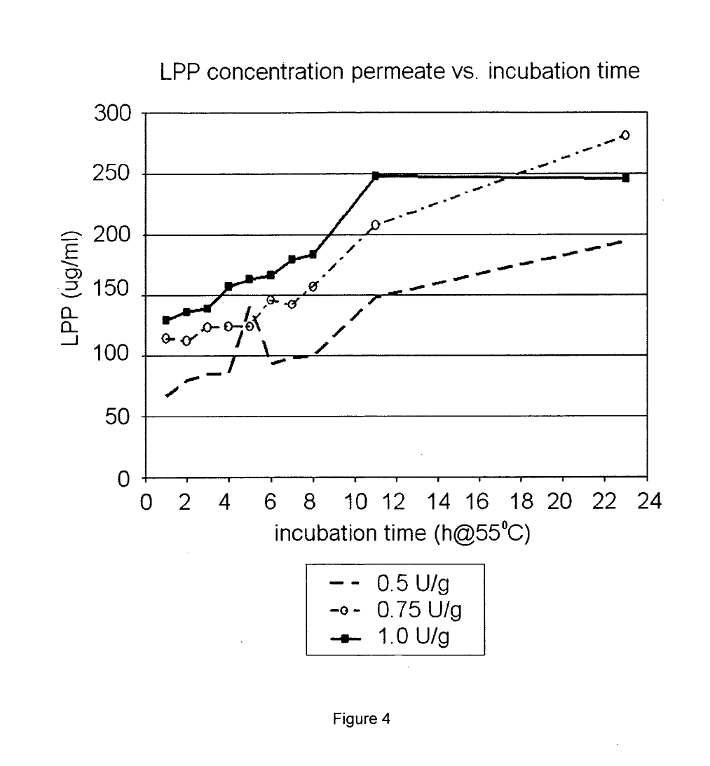

Potassium caseinate (DMV, The Netherlands) was dissolved in water to obtain a liquid incorporating approximately 8% (w/w) of protein and with a pH of approximately 6.6. Then the pH was lowered to 5.9 and the liquid was distributed over a number of shake flasks and the pure proline-specific endoprotease was added in concentrations of 5, 7.5 and 10 mg enzyme protein per gram of milk protein present. Incubation took place at 55 degrees C. with shaking for a period up to 24 hours. Samples were taken at regular intervals and heated for 30 minutes at 90 degrees C. to stop all microbial and enzymatic activities. These heated samples were then centrifuged for 10 minutes at 6000 rpm in an Eppendorf centrifuge after which the supernatant fractions were further purified through a “Vivaspin” centrifugal concentrator (Vivascience, Sartorius Biolab Products, Germany) and centrifuged at 3200 g for 30 minutes in a swing-out rotor. The resulting permeate was directly analyzed by LC/MS to quantitate the levels of IPP, VPP and LPP present in each sample. The results obtained for IPP are illustrated in FIG. 3, for LPP in FIG. 4.

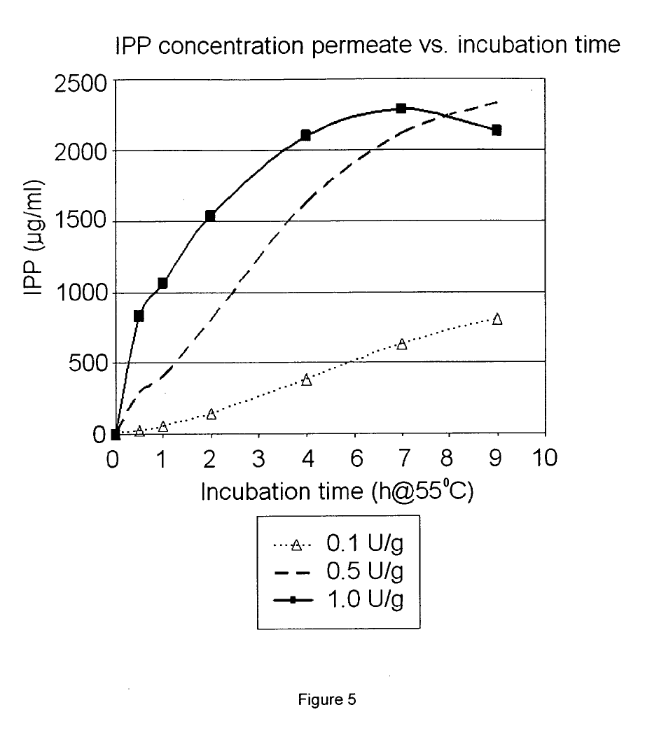

In the case of GMP a similar approach was followed. GMP was dissolved to reach a concentration of 7% (w/w) in water after which the pH was adjusted to 5.9. Incubation with the pure proline-specific endoprotease in concentrations of 5, 7.5 and 10 mg enzyme protein per gram of milk protein present. took place at 55 degrees Celsius with shaking for a period up to 8 hours. Samples were processed as described for caseinate and analysed for IPP and LPP concentrations yielding the results illustrated in FIG. 5. On the basis of the results obtained, it can be concluded that a dosage of approximately 10 mg of the proline-specific protease per gram of (milk) protein present is adequate to release all blood pressure lowering peptides present.

### Example 4

### Blood Pressure Lowering Peptides in Skim Milk, Potassium Caseinate and Glycomacropeptide Solutions Fermented by Various Microorganisms in the Presence of Various Enzymes

As illustrated in Examples 1 and 2, even the use of selected, highly proteolytic lactobacillus species, can not guarantee the release of all blood pressure lowering peptides during fermentation. The implication is that many microorganisms with less proteolytic capacities, will be totally unable to generate blood pressure lowering peptides if grown on a milk protein containing substrate. However, fermenting milk proteins with such microorganisms could be desirable for other aspects, for example because these microorganisms are suitable as a probiotic or they improve the product in terms of texture or taste. According to the enzyme approach according to the present invention, the release of blood pressure lowering peptides from a milk protein is no longer dependent on the nature of the fermenting strains used. Therefore, the enzyme approach according to the present invention allows the combination of several benefits in a single product, i.e. improved taste, texture, probiotic activity combined with a blood pressure lowering activity.

In the present Example we illustrate that the release of blood pressure lowering peptides according to the method of the invention is highly reproducible, also if different milk protein containing substrates are involved. Moreover, we illustrate that the blood pressure lowering peptides can be generated under all these circumstances and in combination with a large variety of industrially used microorganisms. The identity and properties of the lactic acid bacteria or Bifidobacteria used in this experiment are detailed in Table 2.

TABLE 2
Microorganisms tested

| Code | Strain tested | Commercial use |
|---|---|---|
| 100H | Lactobacillus helveticus | Flavor enhancement in |
| | | cheese and fermented milk |
| | | applications. Typically |
| | | selected for its high |
| | | proteolytic activity and |
| | | debittering activity. |
| CY-221 | Streptococcus thermophilus and | Traditional yogurt culture |
| | Lactobacillus delbruecki subsp. | yielding texture and yogurt |
| | bulgaricus | flavor |
| MY-721 | Streptococcus thermofilus, | Yogurt culture yielding |
| | Lactobacillus delbruecki | texture and flavor in |
| | subsp. bulgaricus and | combination with a |
| | Bifidobacterium lactis | probiotic culture. |
| UX-21B | L. lactis subsp. lactis, cremoris | Culture used in Gouda |
| | and diacetylactis | cheese for flavor |
| | | enhancement |
| “Yakult” | Lactobacillus. caseï shirota | Probiotic |
| “Vifit” | Lactobacillus rhamnosus | Yogurt drink |
| | Gorbach & Goldin with | incorporating a |
| | Streptococcus thermophilus | probiotic culture |
| | and Lactobacillus. delbrueckii | |
| | subsp. bulgaricus | |

Codes 100H, CY-221, MY-721 and UX-21B refer to starter cultures commercially available from DSM-Food Specialities (Delft, The Netherlands). “Yakult” and “Vifit” refer to inocula obtained from commercial products marketed under these names.

Strains used were pre-incubated for a period of 22 hours at 37° C. in 25 ml UHT skim milk to which 0.1% yeast extract was added. Liquids inoculated with strains UX-21B were always incubated at 30° C. “Yakult” and “Vivit” strains were obtained by inoculating 0.5 ml of the commercially available products.

For the actual test, three different growth media each incorporating a different milk protein component were prepared: UHT skim milk, a 35 g/l potassium caseinate solution in demineralized water and a 35 g/l GMP solution in demineralized water. All three liquids were enriched by adding an additional 0.1% (w/w) yeast extract. To the caseinate and the GMP solutions also 0.1% (w/w) of lactose was added.

The caseinate and the GMP solutions were pasteurized in a water bath by pre-heating for 15 minutes at 90 degrees C. followed by 30 minutes at a 85 degrees C. Then, UHT milk, caseinate and GMP media were each divided into three portions: no enzyme added, proline-specific endoprotease added (15 mg enzyme protein/g milk protein) and proline-specific endoprotease plus aminopeptidase (Corolase LAP) added (125 microliter/g milk protein). The nine protein/enzyme media samples thus obtained were all individually inoculated with 0.5 ml pre-culture of each one of the six strains (0.5 ml pre-culture per 50 ml growth medium) shown in Table 2. One sample of each of the nine media was not inoculated but served as a reference. Media were incubated standing at 37 degrees C. for 24 hours; media inoculated with strain UX-21B were incubated at 30° C.

At the end of the incubation, small samples were taken from each incubation vial and heated for 30 minutes at 90 degrees C. to stop all microbial and enzymatic activities. These heated samples were then processed as described in Example 3 and analyzed by LC/MS to quantitate the levels of the tripeptides IPP, VPP and LPP present in each sample. The results obtained are presented in Table 3 (UHT milk), Table 4 (potassium caseinate) and Table 5 (GMP). On the basis of the results presented in the latter three tables it can be concluded that the combination of enzyme and fermentation technology according to the present invention offers an efficient way of preparing milk protein based consumer products incorporating high levels of blood pressure lowering peptides.

TABLE 3
Concentration of blood pressure lowering tripeptides in micrograms/ml
in UHT skim milk after incubation as such, inoculated with
various microorganisms, with proline-specific endoprotease
(PSE) added, with aminopeptidase (LAP) added or with a combination
of microorganisms and enzymes added.

| Enzyme | Strain | IPP | LPP | VPP |
|---|---|---|---|---|
| — | — | <0.2 | <0.2 | <0.2 |
| — | L. helveticus (100H) | 15.2 | 0.3 | 17.2 |
| — | S. thermophilus and L. delbruckii | 0.3 | <0.2 | 0.3 |
| | (CY-221) | | | |
| — | Probiotic yogurt culture with | <0.2 | <0.2 | <0.2 |
| | Bifidobacterium lactis (MY-721) | | | |
| — | Gouda culture, L. lactis subsp. lactis | <0.2 | <0.2 | 0.3 |
| | and cremoris, L. lactis subsp. Lactis | | | |
| | variant diacetylactis (UX-21B) | | | |
| — | L. shirota (Yakult) | <0.2 | <0.2 | <0.2 |
| — | LGG (Vivit) | 0.5 | <0.2 | 0.7 |
| PSE | — | 25.5 | 37.8 | 2.3 |
| PSE | L. helveticus (100H) | 30.8 | 62.7 | 2.7 |
| PSE | S. thermophilus and L. delbruckii | 27.3 | 41.5 | 5.0 |
| | (CY-221) | | | |
| PSE | Probiotic yogurt culture with | 27.5 | 45.0 | <4 |
| | Bifidobacterium lactis (MY-721) | | | |
| PSE | Gouda culture, L. lactis subsp. lactis | 26.4 | 38.4 | 4.6 |
| | and cremoris, L. lactis subsp. Lactis | | | |
| | variant diacetylactis (UX-21B) | | | |
| PSE | L. shirota (Yakult) | 27.3 | 47.0 | 5.9 |
| PSE | LGG (Vivit) | 32.7 | 52.9 | 12.5 |
| PSE + LAP | — | 75.7 | 47.2 | 59.7 |
| PSE + LAP | L. helveticus (100H) | 52.3 | 76.5 | 79.6 |
| PSE + LAP | S. thermophilus and L. delbruckii | 46.8 | 55.4 | 62.9 |
| | (CY-221) | | | |
| PSE + LAP | Probiotic yogurt culture with | 46.6 | 60.2 | 67.0 |
| | Bifidobacterium lactis (MY-721) | | | |
| PSE + LAP | Gouda culture, L. lactis subsp. lactis | 40.5 | 49.2 | 63.7 |
| | and cremoris, L. lactis subsp. Lactis | | | |
| | variant diacetylactis (UX-21B) | | | |
| PSE + LAP | L. shirota (Yakult) | 46.3 | 56.5 | 68.8 |
| PSE + LAP | LGG (Vivit) | 46.7 | 57.4 | 62.0 |

The omission of strain or enzyme from the incubation mixture is indicated by —.

TABLE 4
Concentration of blood pressure lowering tripeptides in micrograms/ml
in a potassium caseinate solution after incubation as such, inoculated
with various microorganisms, with proline-specific endoprotease
(PSE) added, with aminopeptidase (LAP) added or with a combination
of microorganisms and enzymes added.

| Enzyme | Strain | IPP | LPP | VPP |
|---|---|---|---|---|
| — | — | <0.2 | <0.2 | <4 |
| — | L. helveticus (100H) | <0.2 | <0.2 | <0.2 |
| — | S. thermophilus and L. delbruckii | <0.2 | <0.2 | <0.2 |
| | (CY-221) | | | |
| — | Probiotic yogurt culture with | <0.2 | <0.2 | <0.2 |
| | Bifidobacterium lactis (MY-721) | | | |
| — | Gouda culture, L. lactis subsp. lactis | <0.2 | <0.2 | <0.2 |
| | and cremoris, L. lactis subsp. Lactis | | | |
| | variant diacetylactis (UX-21B) | | | |
| — | L. shirota (Yakult) | <0.2 | <0.2 | <0.2 |
| — | LGG (Vivit) | <0.2 | <0.2 | <0.2 |
| — | — | 14.3 | 47.5 | <4 |
| PSE | L. helveticus (100H) | 11.3 | 36.8 | <4 |
| PSE | S. thermophilus and L. delbruckii | 14.9 | 49.4 | <4 |
| | (CY-221) | | | |
| PSE | Probiotic yoghurt culture with | 14.5 | 47.6 | <4 |
| | Bifidobacterium lactis (MY-721) | | | |
| PSE | Gouda culture, L. lactis subsp. lactis | 11.4 | 44.7 | <4 |
| | and cremoris, L. lactis subsp. Lactis | | | |
| | variant diacetylactis (UX-21B) | | | |
| PSE | L. shirota (Yakult) | 14.7 | 48.8 | <4 |
| PSE | LGG (Vivit) | 15.5 | 50.7 | <4 |
| PSE + LAP | — | 50.7 | 54.9 | 72.8 |
| PSE + LAP | L. helveticus (100H) | 35.3 | 56.9 | 80.7 |
| PSE + LAP | S. thermophilus and L. delbruckii | 38.1 | 55.8 | 76.5 |
| | (CY-221) | | | |
| PSE + LAP | Probiotic yoghurt culture with | 34.4 | 56.0 | 76.5 |
| | Bifidobacterium lactis (MY-721) | | | |
| PSE + LAP | Gouda culture, L. lactis subsp. lactis | 26.9 | 55.2 | 77.0 |
| | and cremoris, L. lactis subsp. Lactis | | | |
| | variant diacetylactis (UX-21B) | | | |
| PSE + LAP | L. shirota (Yakult) | 35.1 | 55.8 | 76.4 |
| PSE + LAP | LGG (Vivit) | 39.8 | 54.9 | 73.4 |

The omission of strain or enzyme from the incubation mixture is indicated by —.

TABLE 5
Concentration of blood pressure lowering tripeptides in micrograms/ml
in GMP solution after incubation as such, inoculated with
various microorganisms, with proline-specific endoprotease
(PSE) added, with aminopeptidase (LAP)added or with a combination
of microorganisms and enzymes added.

| Enzyme | Strain | IPP | LPP | VPP |
|---|---|---|---|---|
| — | — | <0.2 | nd | nd |
| — | L. helveticus (100H) | 1.5 | nd | nd |
| — | S. thermophilus and L. delbruckii | nd | nd | nd |
| | (CY-221) | | | |
| — | Probiotic yoghurt culture with | nd | nd | nd |
| | Bifidobacterium lactis (MY-721) | | | |
| — | Gouda culture, L. lactis subsp. lactis | nd | nd | nd |
| | and cremoris, L. lactis subsp. Lactis | | | |
| | variant diacetylactis (UX-21B) | | | |
| — | L. shirota (Yakult) | nd | nd | nd |
| — | LGG (Vivit) | nd | nd | nd |
| PSE | — | 523 | nd | nd |
| PSE | L. helveticus (100H) | 556 | nd | nd |
| PSE | S. thermophilus and L. delbruckii | 612 | nd | nd |
| | (CY-221) | | | |
| PSE | Probiotic yoghurt culture with | 632 | nd | nd |
| | Bifidobacterium lactis (MY-721) | | | |
| PSE | Gouda culture, L. lactis subsp. lactis | 579 | nd | nd |
| | and cremoris, L. lactis subsp. Lactis | | | |
| | variant diacetylactis (UX-21B) | | | |
| PSE | L. shirota (Yakult) | 604 | nd | nd |
| PSE | LGG (Vivit) | 601 | nd | nd |
| PSE + LAP | — | 487 | nd | nd |
| PSE + LAP | L. helveticus (100H) | 532 | nd | nd |
| PSE + LAP | S. thermophilus and L. delbruckii | 544 | nd | nd |
| | (CY-221) | | | |
| PSE + LAP | Probiotische yoghurt culture with | 548 | nd | nd |
| | Bifidobacterium lactis (MY-721) | | | |
| PSE + LAP | Gouda culture, L. lactis subsp. lactis | 507 | nd | nd |
| | and cremoris, L. lactis subsp. Lactis | | | |
| | variant diacetylactis (UX-21B) | | | |
| PSE + LAP | L. shirota (Yakult) | 526 | nd | nd |
| PSE + LAP | LGG (Vivit) | 569 | nd | nd |

The omission of strain or enzyme from the incubation mixture is indicated by —. Not detectable levels of LPP and VPP are indicated by nd.

### Example 5

### Blood Pressure Lowering Peptides in Fermented Skim Milk Hydrolysates

According to the enzyme approach according to the present invention, the release of blood pressure lowering peptides from a milk protein may no longer be dependent on the nature of the fermenting strains used. Therefore, the enzyme approach according to the present invention allows the combination of two benefits in a single product, i.e. improved taste, texture, probiotic activity (as brought about by the fermenting strain selected) combined with a blood pressure lowering activity. The enzyme approach makes the whole process much more versatile as the enzyme(s) guarantee a high yield of blood pressure lowering peptides so that the fermentation step becomes flexible, i.e. the fermentation process can be carried out before, during or even after enzyme incubation. Incubating the milk protein containing substrate with the enzymes prior to the fermentation process is of special interest as this allows the inactivation of the enzymes so that the final product incorporating blood pressure lowering peptides can contain viable microorganisms. The latter feature may be of importance for probiotic products as well as for special yogurts.

In the present Example we describe a fermentation process which is carried out after an enzyme treatment of the skim milk. Moreover, the effect of various types of aminopeptidases on the yield of blood pressure lowering peptides is illustrated. From commercially available UHT skim milk a 10 ml sample was taken as reference material. To the remaining 990 ml skim milk, first 35 PPU of the proline-specific protease was added and quickly mixed. From this material, 11 portions of 10 ml were obtained. To ten of these portions an aminopeptidase preparation was added according to the schedule specified in Table 6. The remaining portion served as a reference and no aminopeptidase was added. Incubation of all these samples took place for 4 hours at 55 degrees C. with shaking after which the enzymes present were inactivated by a heat treatment of 15 minutes at 95 degrees C. Then, one ml samples of each portion were centrifuged, supernatants were processed as described in Example 3 and analyzed by LC/MS to quantitate the levels of IPP, VPP and LPP present in each sample. The results obtained are presented in Table 6 and show that upon a pre-incubation with the proline-specific endoprotease alone (Tube 2) significant levels of blood pressure lowering peptides can be obtained. However, adding aminopeptidase activity (Tubes 3 to 13) enhances these levels to release approximately 90% of all IPP theoretically present in Tube 13.

The remaining nine ml portions (Tubes 1 to 13) were cooled down, any protein precipitates were removed by centrifugation and the resulting supernatants were all inoculated with a traditional yogurt culture CY-340 (available from DSM-Food Specialities, Delft, The Netherlands). After an incubation of 10 hours at 37 degrees C., the various end products were evaluated in terms of viscosity, taste and cell growth. Except for the tube containing the non-protease treated UHT milk (Tube 1), the viscosity of the various incubates was marginally increased as the result of the fermentation which made them suitable as, for example, a drink yogurt. All inoculated products showed considerable microbiological growth, typically around 10⁹ cfu/ml. Furthermore, all products had a slight, yogurt-like taste. Only the products pre-treated with the P436P enzyme product tasted bitter, presumably because this enzyme product incorporates, apart from its aminopeptidolytic activities, significant amounts of endoproteolytic activity.

TABLE 6
Concentration of blood pressure lowering tripeptides
in micrograms/ml in UHT skim milk.

| | | | | |
|---|---|---|---|---|
| | Aminopeptidase | IPP | LPP | VPP |
| Sample: | added (ul) * | ug/ml | ug/ml | ug/ml |

| Tube 1 | none | | <0.2 | <0.2 | <0.2 |
|---|---|---|---|---|---|
| Tube 2 | none | | 31.3 | 19.7 | <0.2 |
| Tube 3 | 50 | LAP | 34.9 | 24.4 | 24.6 |
| Tube 4 | 250 | LAP | 42.2 | 24.05 | 24.8 |
| Tube 5 | 1000 | LAP | 54.6 | 25.3 | 26.1 |
| Tube 7 | 50 | ZBH | 46.5 | 23.8 | 2.1 |
| Tube 8 | 250 | ZBH | 55.3 | 23.5 | 9.5 |
| Tube 9 | 1000 | ZBH | 60.3 | 21.7 | 24.7 |
| Tube 11 | 50 | P436P | 48.3 | 62.8 | 39.1 |
| Tube 12 | 250 | P436P | 129.4 | 97.2 | 90.4 |
| Tube 13 | 1000 | P436P | 142.7 | 98.1 | 102.0 |

* The aminopeptidases used are specified in the Material & Methods section. To guarantee comparable aminopeptidolytic activities, of each aminopeptidase preparation a solution was prepared that was standardized on the basis of an activity assay using Leu-pNA as the substrate. To that end a saturated solution of Leu-pNA was incubated at pH 6.5 and 37 degrees C. with the various preparations. Liberation of pNA by each preparation was followed kinetically in 10 minutes kinetic measurements at 405 nm using a Tecan-Genios MTP Reader (Salzburg, Vienna). According to the data obtained the ZBH concentrate (14 mg protein/ml) exhibited a comparable aminopeptidolytic activity with a five times diluted (2 mg protein/ml) Corolase LAP (batch 8044) preparation and a solution of 200 mg/ml solution of the P436P powder. The quantities of aminopeptidolytic activities specified in Table 6 refer to volumes obtained from the latter three enzyme solutions.

1. A process to produce a fermented milk product comprising the tripeptide IPP and/or the tripeptide VPP which comprises using a milk protein as starting material, whereby the milk protein is subjected to a fermentation step using a suitable lactic acid bacterium or a Bifidobacterium and to an enzyme incubation step using a proline-specific endoprotease or a proline specific oligopeptidase.

2. A process according to claim 1 wherein a proline-specific endoprotease is used which is obtained from Aspergillus, preferably Aspergillus niger.

3. A process according to claim 1, wherein the proline-specific endoprotease or proline specific oligopeptidase is added in an amount of 0.05 to 1.7 is wt % based on milk protein.

4. A process according to claim to claim 1, whereby further an aminopeptidase is used in the enzyme incubation step.

5. A process according to claim 4 wherein the aminopeptidase is obtained from Aspergillus.

6. A process according to claim 4, wherein the aminopeptidase is added in an amount of less than I wt % based on milk protein.

7. A process according to claim 1, wherein also LPP is produced.

8. A process according to claim 1, wherein the fermented milk product has a Degree of Hydrolysis (DH) of 5 to 38%, preferably of 10 to 38% and more preferably of 15 to 35%.

9. A process according to claim 1, whereby in the fermentation step whereby the lactic acid bacterium or Bifidobacterium is a Lactobacillus, e.g. Lactobacillus helveticus, Lactobacillus acidophilus, Lactobacillus plantarum, Lactobacillus rhamnosus, Lactobacillus bulgaricus or Lactobacillus. deibrueckli ssp. Bulgaricus, a Lactococcus, e.g. Lactococcus lactis, a Leuconostoc, a Pediococcus or a Streptocoocus or is a representant of Bifidobacteria such as Bifidobacterium an/malls, Bifidobacterium brevis, Bifidobacterium infant/s and Bifidobacterium lon gum.

10. A process according to claim 1, wherein the enzymatic step precedes the fermentation step.

11. A process according to claim 1, wherein the enzymatic step takes place during the fermentation step.

12. A process according to claim 1, wherein the enzymatic is step takes place after the fermentation step.

13. A process to produce a food, a feed, a pet food, a neutraceutical or nutritional ingredient or an ingredient to be used in a food, a feed, a pet food, or an neutraceutical, which comprises incorporating a fermented milk product comprising the tripeptide IPP and/or the tripeptide VPP which is produced with the process of claim 1, in said food, feed, pet food, neutraceutical or nutritional ingredient or an ingredient thereof.

14. Food, feed, pet food, neutraceutical or nutritional ingredient or an ingredient to be used in a food, a feed, pet food, or an neutraceutical which is obtainable by the process of claim 13.

15. Use of a fermented milk product comprising the tripeptide IPP and/or VPP produced with the process of claim 1, in the preparation of a food, a feed, a pet food, a neutraceutical or nutritional ingredient or an ingredient to be used in a food, a feed, a pet food, or a neutraceutical.
